(19) United States
(12) Patent Application Publication
(10) Pub. No.: US 2020/0143621 A1
(43) Pub. Date: May 7, 2020

(54) MODULAR STORAGE SYSTEM APPARATUS AND METHODS

(71) Applicant: SupplyPro, Inc., San Diego, CA (US)

(72) Inventor: Michael Reynolds, San Diego, CA (US)

(21) Appl. No.: 16/576,580

(22) Filed: Sep. 19, 2019

Related U.S. Application Data
(60) Provisional application No. 62/734,207, filed on Sep. 20, 2018.

(51) Int. Cl. G07F 11/00; G06Q 10/08

(52) U.S. Cl. CPC G07F 11/007; G06Q 10/087

(57) ABSTRACT

A system and method for producing a supply cabinet system configured to dispense a plurality of items. The method includes determining, for each of a plurality of item types, a number of units of the item type capable of being contained within each of a plurality of dimensional variations of each of a plurality of storage module types. A storage module configuration is selected to contain a target number of the items of each of the item types. Each selected storage module configuration corresponds to a dimensional variation of one of the storage module types. A rack arrangement to hold the selected storage module configurations is determined. The supply cabinet system may then be assembled using a set of storage modules corresponding to the selected storage module configurations and a set of rack members corresponding to the rack arrangement.

### CROSS-REFERENCE TO RELATED APPLICATIONS

This application claims the benefit of priority under 35 U.S.C. § 119(e) of U.S. Provisional Patent Application No. 62/734,207, entitled MODULAR STORAGE SYSTEM APPARATUS AND METHODS, filed on Sep. 20, 2018, the content of which is incorporated herein by reference in its entirety for all purposes.

### BACKGROUND

Embodiments are described herein that relate to computer-controlled storage cabinets, and more particularly to a configurable modular multi-compartment storage system having computer-controlled access.

Conventional supply cabinets are often used in factories, shops, plants, stores or other sites to store small tools, parts, ingredients or other items. The cabinets allow for better organization and space utilization, while simultaneously improving worker productivity by eliminating time wasted looking for items.

Typical supply cabinets are often used to store consumables or small parts that are commonly used within a particular factory or shop. Because these parts are purchased and stored in bulk, accurate inventory and costing of the products made using these parts can be difficult. In addition, misappropriation of the parts can be difficult to detect or prevent.

In some cases, items to be stored may require security to ensure the items are dispensed only to authorized personnel. Such items may include, for example, dangerous elements such as mercury, which may be needed to assemble products such as, for example, mercury switches. Since such items may be too hazardous to allow them to be accessed in an uncontrolled manner, they are often stored in a remote secure location. This unfortunately requires workers to waste time and effort retrieving them. To save time, workers often request excessive quantities of materials remotely stored or otherwise subject to controlled access, resulting in an increase in wasted material, time, and risk.

Further, factories and other industrial sites may have different requirements and needs for storing parts, which may also vary over time. Thus, a need exists for a secure modular storage system that can be configured for a specific need and use and reconfigured as needed as the requirements and needs of the user change.

### SUMMARY

Apparatus and methods are described herein for a modular storage system that can be used to store and dispense parts in a secure and controlled manner. The modular storage system can be selectively configured and reconfigured to meet the needs of a user. The height, depth, width, storage and control requirements can all be uniquely configured to meet the needs of the user. Each stockkeeping unit (SKU) and/or tool can be managed at an efficient level of control, maximizing product density and minimizing costs. The modular storage system can also include software that includes set-up controls and critical process monitors that can detect issues with built in sensors that can monitor and troubleshoot critical functions.

In one aspect the disclosure relates to a method of producing a supply cabinet system configured to dispense a plurality of items. The method includes obtaining product dimension characteristics of the plurality of items wherein the product dimension characteristics include physical dimensions for a plurality of item types included within the plurality of items. For each item type of the plurality of item types, the method includes determining a number of units of the item type capable of being contained within each of a plurality of dimensional variations of each of a plurality of storage module types. One of a plurality of storage module configurations are selected to contain a target number of the items of each one of the plurality of item types wherein each selected storage module configuration corresponds to one of the plurality of dimensional variations of one of the plurality of storage module types. The method further includes determining a rack arrangement to hold the selected storage module configurations. The rack arrangement and the selected storage module configurations form at least a part of a supply cabinet configuration. The method further includes assembling, in accordance with the supply cabinet configuration, the supply cabinet system using a set of storage modules corresponding to the selected storage module configurations and a set of rack members corresponding to the rack arrangement.

In another aspect the disclosure relates to a supply cabinet system configured to dispense a plurality of items. The supply cabinet system includes a rack arrangement and a set of storage modules disposed within the rack arrangement. The set of storage modules correspond to a set of selected storage module configurations. Each of the selected storage module configurations (i) are dimensioned to contain a number of units of an item type included among a plurality of item types, and (ii) correspond to one of a plurality of potential dimensional variations of one of a plurality of storage module types. The set of selected storage module configurations are determined in accordance with a design parameter, the design parameter relating to one of space minimization, cost and a surface configuration of the supply cabinet system.

The disclosure is also directed to a method of facilitating production of a supply cabinet system configured to dispense a plurality of items. The method includes obtaining product dimension characteristics of the plurality of items. The product dimension characteristics may include physical dimensions for a plurality of item types included within the plurality of items. For each item type of the plurality of item types, the method includes determining a number of units of the item type capable of being contained within each of a plurality of dimensional variations of each of a plurality of storage module types. One of a plurality of storage module configurations is selected to contain a target number of the items of each one of the plurality of item types wherein each selected storage module configuration corresponds to one of the plurality of dimensional variations of one of the plurality of storage module types. The method further includes determining a rack arrangement to hold the selected storage module configurations, the rack arrangement and the selected storage module configurations forming at least a part of a supply cabinet configuration. The supply cabinet configuration is usable to assemble the supply cabinet using a set of storage modules corresponding to the selected storage module configurations and a set of rack members corresponding to the rack arrangement.

### BRIEF DESCRIPTION OF THE FIGURES

FIG. 1A is a perspective view of a storage system, according to an embodiment.

FIG. 1B is an exploded perspective view of a rack of the storage system of FIG. 1A; and FIG. 1C is an assembled perspective view of the rack of FIG. 1B.

FIG. 2A is an exploded perspective view of a set of racks of a storage system, according to an embodiment and FIG. 2B is an assembled perspective view of the set of racks of FIG. 2A.

FIG. 3A is a perspective view of a set of racks of a storage system according to an embodiment; FIG. 3B is a perspective view of one of the racks of FIG. 3A; and FIG. 3C is a perspective view of the other of the racks of FIG. 3A.

FIG. 4 is a perspective view of a rack according to another embodiment.

FIG. 5 is a perspective view of a set of racks of a storage system according to an embodiment.

FIG. 6 is a perspective view of a storage system, according to an embodiment.

FIGS. 7, 12A, 12B, 13A, 13B, 13C, 14A, 14B, 14C, 15A, 15B, 16A, 16B, 16C and 17 illustrate various different embodiments of a door storage unit

FIGS. 18-22 illustrate various different embodiments of a drawer storage unit.

FIG. 23 is a perspective view of a portion of a storage system including a helix coil system.

FIG. 24 is an enlarged view of a portion of the storage system of FIG. 23.

FIG. 25 is a perspective view of the portion of the storage system of FIG. 23 illustrating a door open and visible contents.

FIGS. 26 and 27 are each a perspective view of a different embodiment of a storage unit.

FIG. 28 is a perspective view of a storage cabinet according to an embodiment.

FIG. 29 is a perspective view of a storage unit, according to an embodiment.

FIG. 30 is a perspective view of a storage unit according to an embodiment illustrating a lock mechanism in a locked position.

FIG. 31 is an enlarged view of the lock mechanism of FIG. 30.

FIG. 32 is a perspective view of the storage unit of FIG. 30 illustrating the lock mechanism in an unlocked position.

FIG. 33 is an enlarged view of the lock mechanism of FIG. 32.

FIG. 34 is a perspective view of a storage unit according to an embodiment.

FIGS. 35A, 35B and 36 each illustrate a carousel of the storage unit of FIG. 34.

FIGS. 37-39 are each a perspective view of a different embodiment of a storage unit.

FIG. 40 illustrates a system for facilitating the design, configuration and assembly of configurable supply cabinets in accordance with the disclosure.

FIGS. 41A-41C illustrate a flowchart representative of a process for configuring a supply storage and inventory control system, according to an embodiment.

FIG. 42 illustrates an exemplary set of drawer structures which may be utilized within supply cabinet system configurations generated in accordance with the disclosure.

FIGS. 43, 44, 45A, and 45B illustrate examples of various different types of supply cabinet system configurations which may be produced by a supply configurator module in accordance with the disclosure.

### DETAILED DESCRIPTION

Apparatus and methods are described herein, and in Exhibit A and Exhibit B attached hereto and incorporated herein by reference, for a modular storage and inventory control system that can be used to store and dispense parts in a secure and controlled manner. The modular storage system can be selectively configured and reconfigured to meet the needs of a user. The height, depth, width, storage and control requirements can all be uniquely configured to meet the needs of the user. Each stockkeeping unit (SKU) and/or tool can be managed at an efficient level of control, maximizing product density and minimizing costs. The modular storage system can include software that includes state-of-the art set-up controls and critical process monitors that can detect issues with built in sensors that can monitor and troubleshoot critical functions that have auto-correct and alert functions.

The apparatus and methods described herein can provide efficient inventory control systems with numerous different possible configurations. The system can include a supply configurator operative to analyze the indirect materials inventory, use advanced algorithms based on historical data from known inventory transactions to provide recommendations to optimize the inventory control, and provide tools to allow for changes to be made based on the user's own experience and insight.

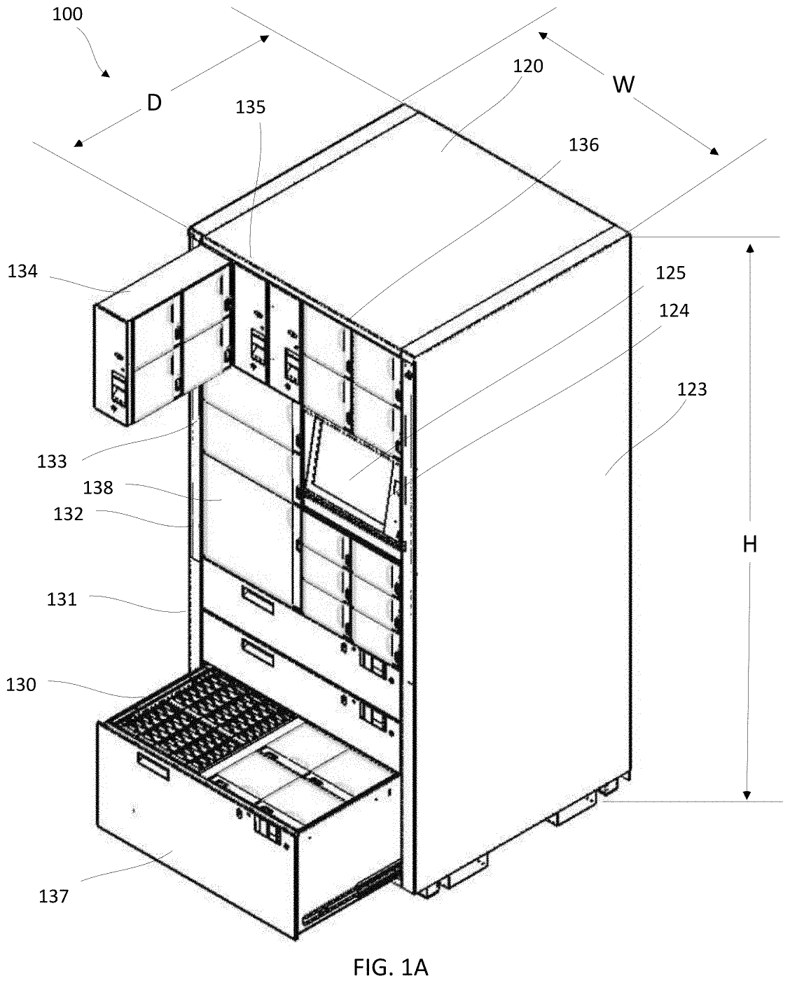

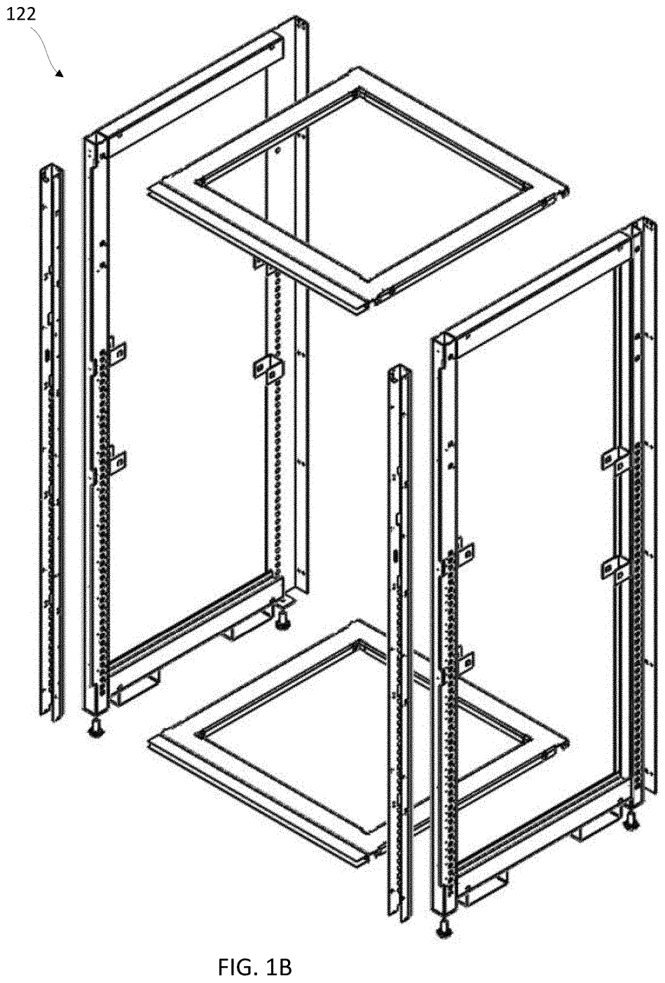

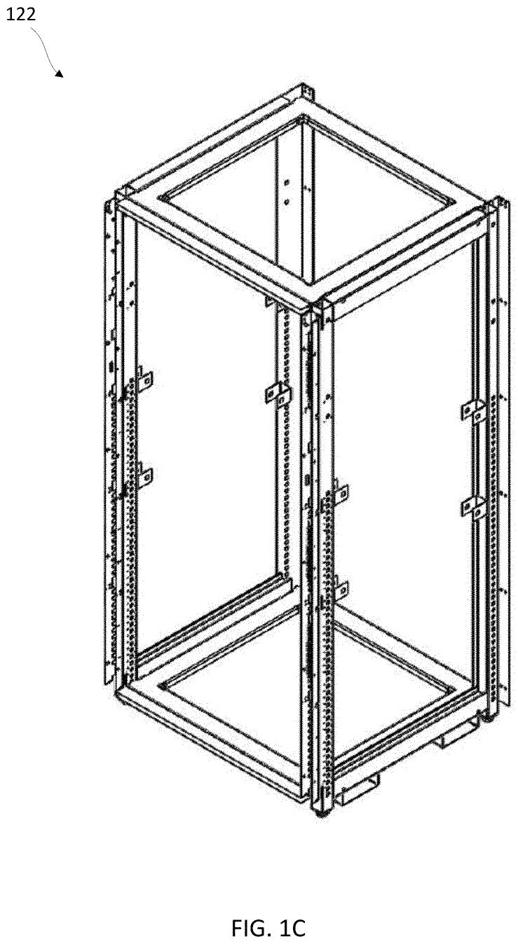

Turning to the Figures, as shown in FIGS. 1A-1C, a modular storage and inventory control system 100 (also referred to herein as “storage system”) includes at least one cabinet 120 that includes a control rack or frame 122 that houses a control unit 124. Such a cabinet is also referred to as the control cabinet. The control unit 124 includes a central processing unit (CPU) (not shown), touch screen 125 and a power supply array (not shown). The control unit 124 can be inserted and removed from the control rack without the use of tools in a snap-in and snap-out manner to facilitate easy on site replacements without the need for a specialized technician. The control unit 124 can be electrically coupled to the various compartments within the cabinet 120 and also to additional cabinets 120 coupled to the control rack 122 and control unit 124 as described in more detail herein. In the simplest form, the storage system includes a single cabinet 120 with the control rack 122 and control unit 124. The cabinet 120 also includes a housing 123 that includes panels sized to enclose the rack 122 on, for example, the back side, top, one or more sides, etc., leaving the front open to receive one or more storage units described in more detail below. Various different configurations of the storage system 100 can be designed by adding additional cabinets 120 and/or racks 122 as needed to meet the needs of the particular situation. Thus, the storage system 100 is completely modular and can be reconfigured by adding or removing racks, and storage units as needed.

The storage system 100 can include various different types of cabinets 120 to provide different types of storage and different levels of security within the storage system 100. For example, in some embodiments, a cabinet 120 can include a storage unit that includes a radio-frequency identification (RFID) system for tracking the removal and addition of items within a storage unit. In some embodiments, a cabinet can include storage units that have optical tracking capabilities. Various other types of storage units and cabinets are described herein.

In addition to various types of cabinets 120 having various features, the cabinets 120 can have various sizes. The cabinets 120 can have various heights H, widths W, and depths D as shown in FIG. 1A. For example, in some embodiments, the cabinet 120 shown in FIGS. 1A-1C can have a height of 79 inches, a width of 37 inches and a depth of 36 inches. In other embodiments, the cabinet 120 can have, for example, a height of 79 inches, a width of 37 inches and a depth of 36 inches. It should be understood that these are example dimensions and that other sizes can be included.

As referred to herein, the size of the cabinets can be referenced based on the number and size of storage units it can hold. For example, the cabinet 120 of FIGS. 1A-1C is a 5×2×2, which means it is 5 storage units high, 2 storage units wide and 2 storage units deep. Said another way, the cabinet 120 can include 5 levels or modules 130, 131, 132, 133, 134 in the height direction, and on each level there can be one (a double wide) or two (two single wide) storage units 135, 136 in the width direction. For example, in FIG. 1A, levels 130 and 131 each have a double wide storage unit, and levels 132-134 each have two single wide storage units. In this embodiment, the depth of each storage unit is referred to as a double depth. Other embodiments described herein can include various combinations of number of levels, single and double wide storage units and single and double depth storage bins.

Various types of storage units can be included within a storage cabinet 120. For example, various combinations of drawer storage units, such as drawer storage unit 137, and door storage units, such as door storage unit 138, can be included, as shown in FIG. 1A. The door storage units can have one or more doors that provide access to one or more compartments within the storage unit and can provide for single or multi SKU storage compartments. Similarly, the drawer storage units can have one or more compartments within a drawer 137. In some embodiments, a drawer storage unit can include a cover. In some embodiments, a drawer storage unit is open no a top or side of the drawer bin to provide access to its contents. In some embodiments, a drawer storage unit can include compartments for cartridges, cassettes or other items.

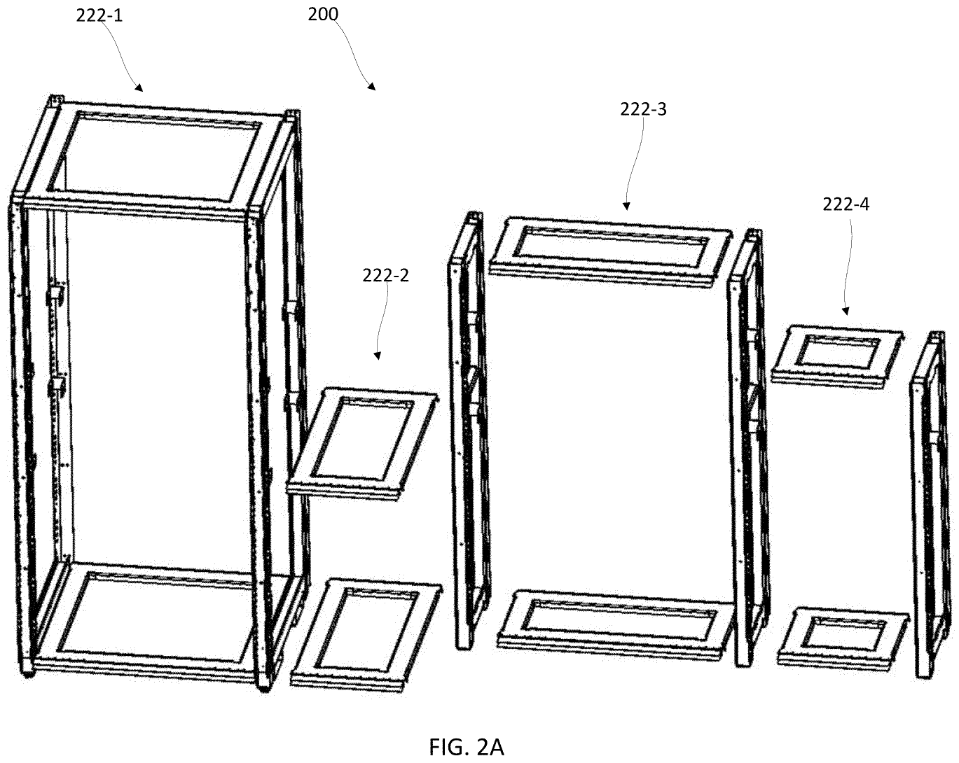

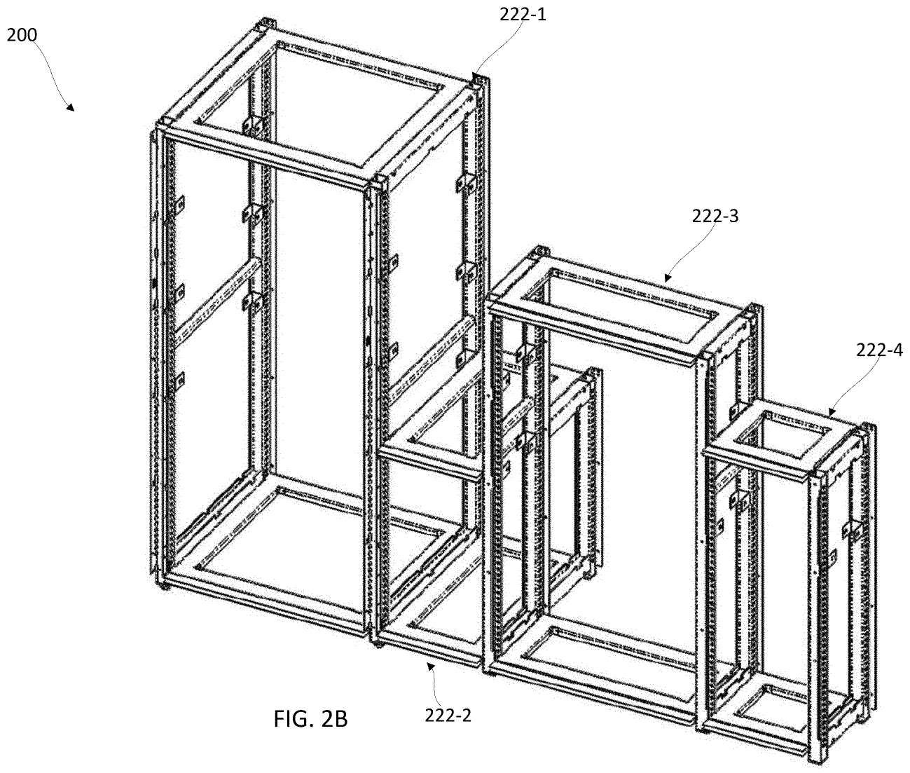

FIGS. 2A and 2B show a set of racks for a storage system 200 to illustrate an example combination of racks/cabinets that can be assembled and included in a storage system. In this embodiment, four cabinets are formed by the racks 222-1, 222-2, 222-3, and 222-4. The first rack 222-1 is the same size as rack 122 (i.e., a 5×2×2), the second rack 222-2 is a 2×1×2, the third rack 222-3 is a 4×2×1 and the forth rack 222-4 is a 3×1×1. As shown in the exploded view of FIG. 2A, the rack 222-2 can be formed with a top and bottom frame that can be directly attached to the side frames of racks 222-1 and 222-3. Similarly, the rack 222-4 can be attached to the side frame of rack 222-3.

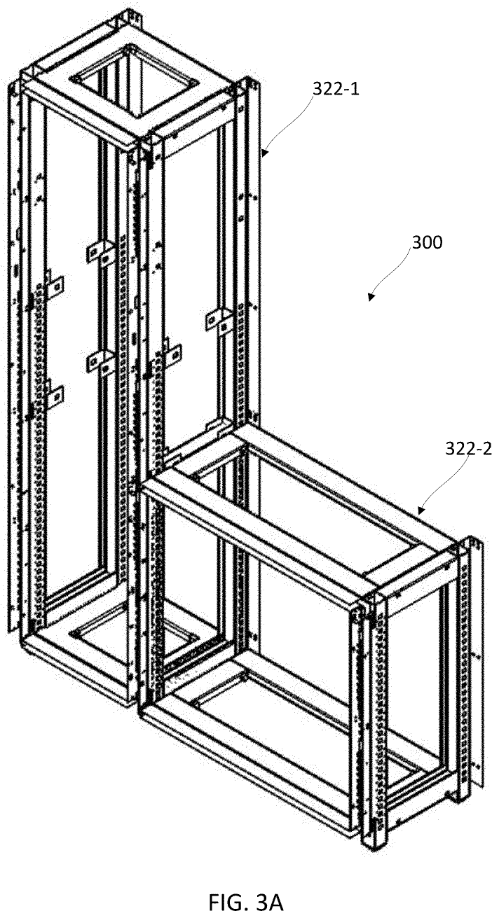

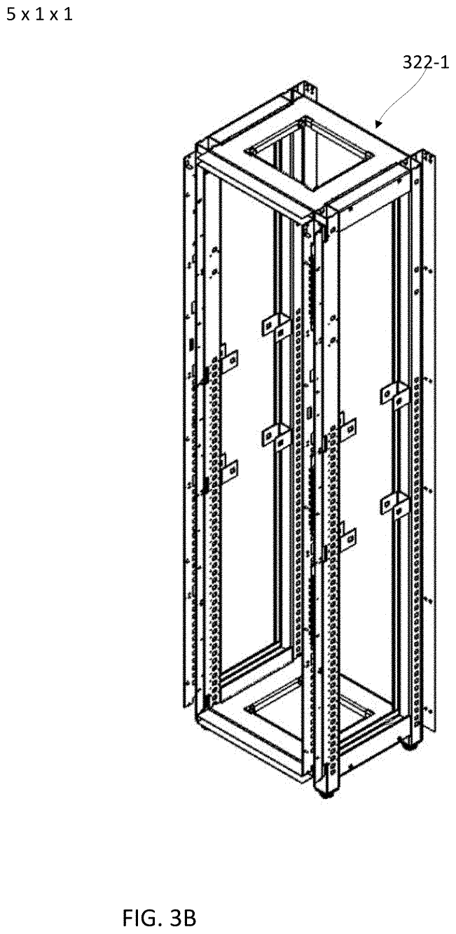

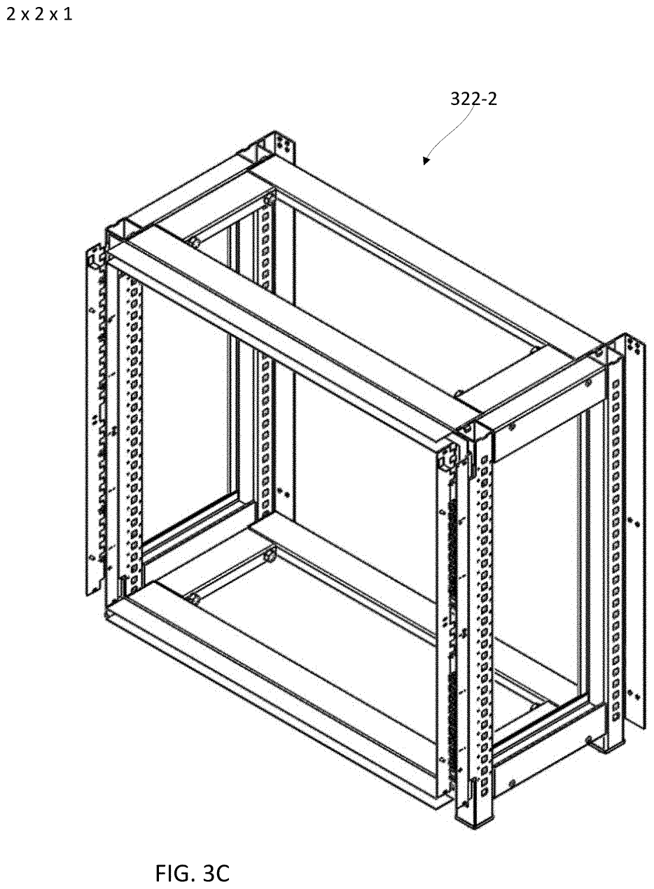

FIGS. 3A and 3B show another set of racks for a storage system 300. In this embodiment, a first rack 322-1 is a 5×1×1 and a second rack 322-2 is a 2×2×1. In this embodiment, each of the racks 322-1 and 322-2 have top, bottom and side frames that can then be coupled together. FIG. 4 is an illustration of a rack 422 that is a 3×1×2.

FIG. 5 illustrates a set of racks for another embodiment of a storage system 500. In this embodiment, the storage system 500 includes a first rack 522-1 that is a 5×1×2, a second rack 522-2 that is a 3×2×2, a third rack 522-3 that is a 5×1×1, and a fourth rack 522-4 that is a 2×2×1.

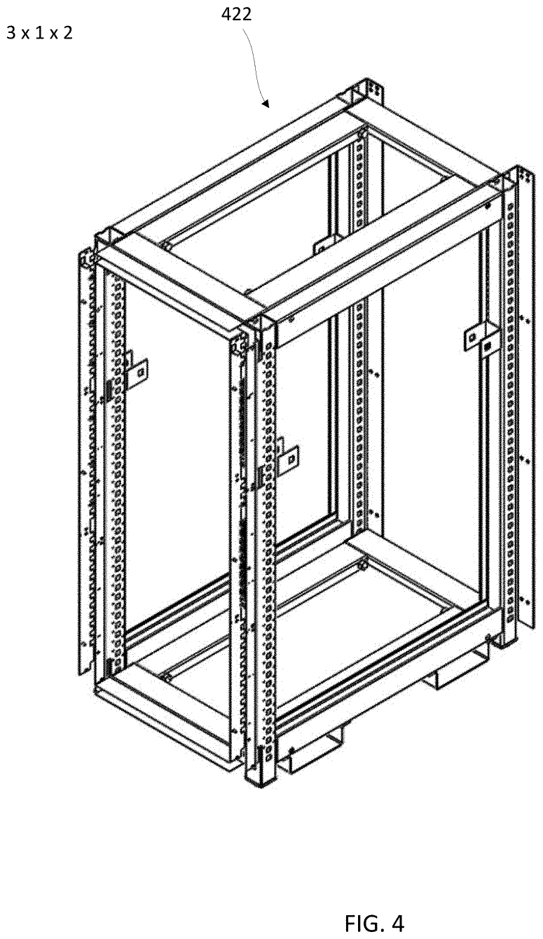

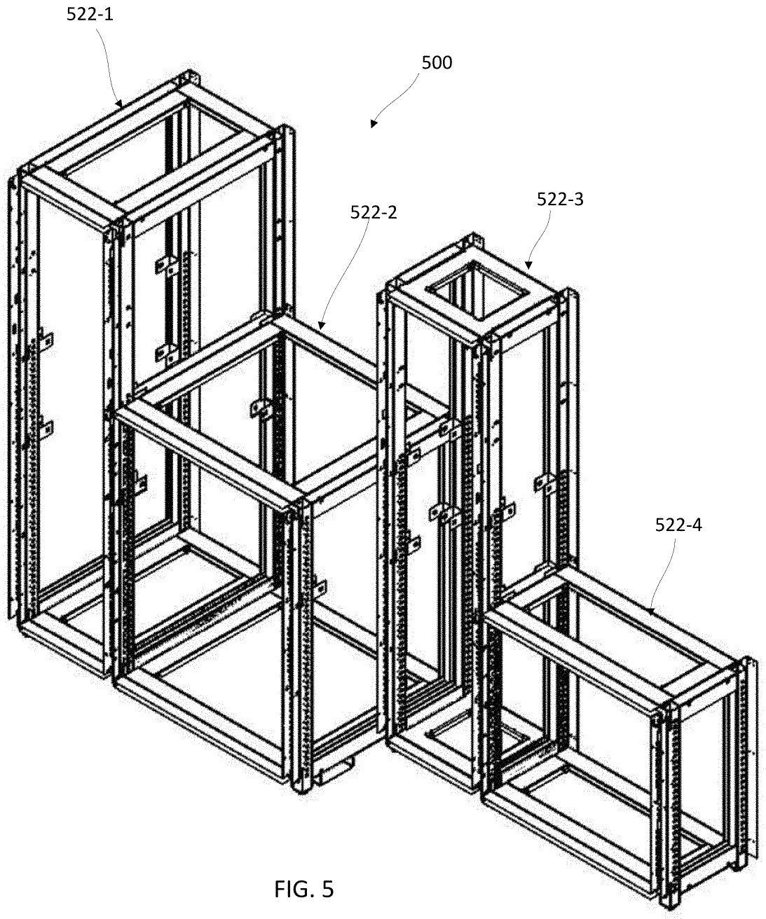

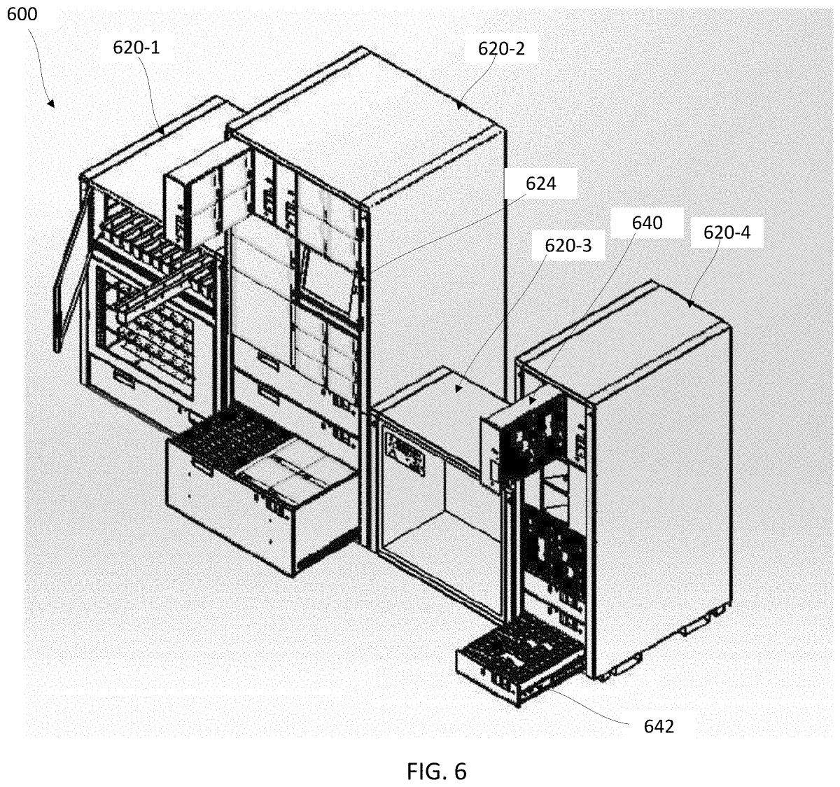

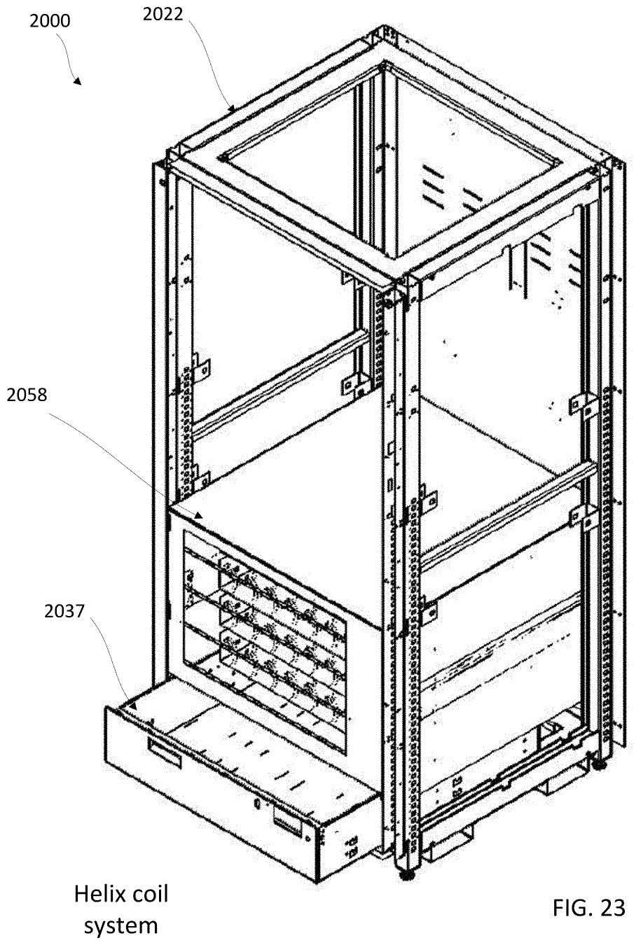

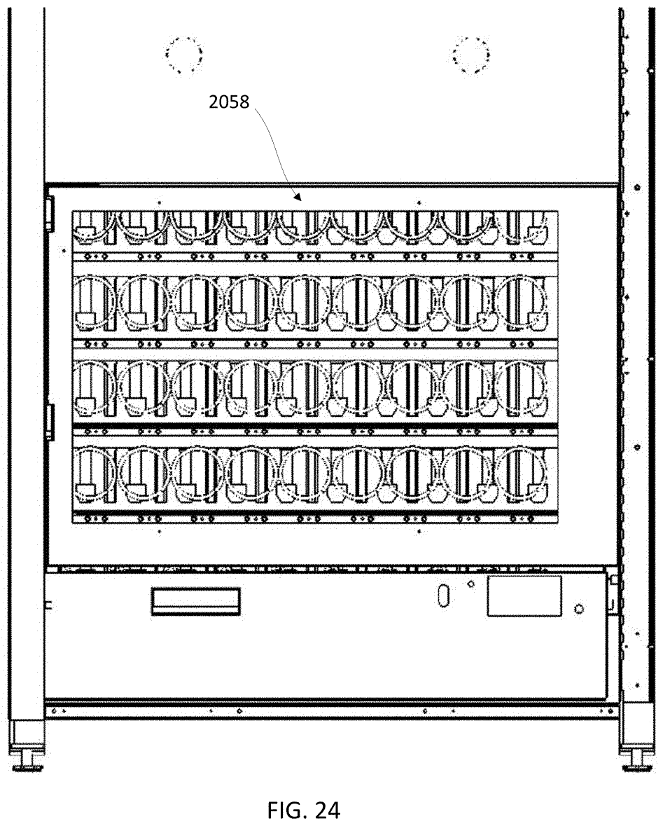

FIG. 6 illustrates a storage system 600 that includes a first cabinet 620-1, a second cabinet 620-2, a third cabinet 620-3 and a fourth cabinet 620-4. In this embodiment, the cabinet 620-2 includes the control rack (not shown) and control panel 624. Each of the cabinets includes various types of storage units (e.g., drawer and door storage units). Cabinet 620-1 illustrates an embodiment of a helix coil dispensing system (described in more detail below with reference to FIGS. 23-24. Cabinet 620-3 illustrates an embodiment of a cabinet with a radio-frequency identification (RFID) system. Cabinet 620-4 illustrates drawer storage units 640 that are vertically oriented and drawer storage units 642 that are horizontally oriented.

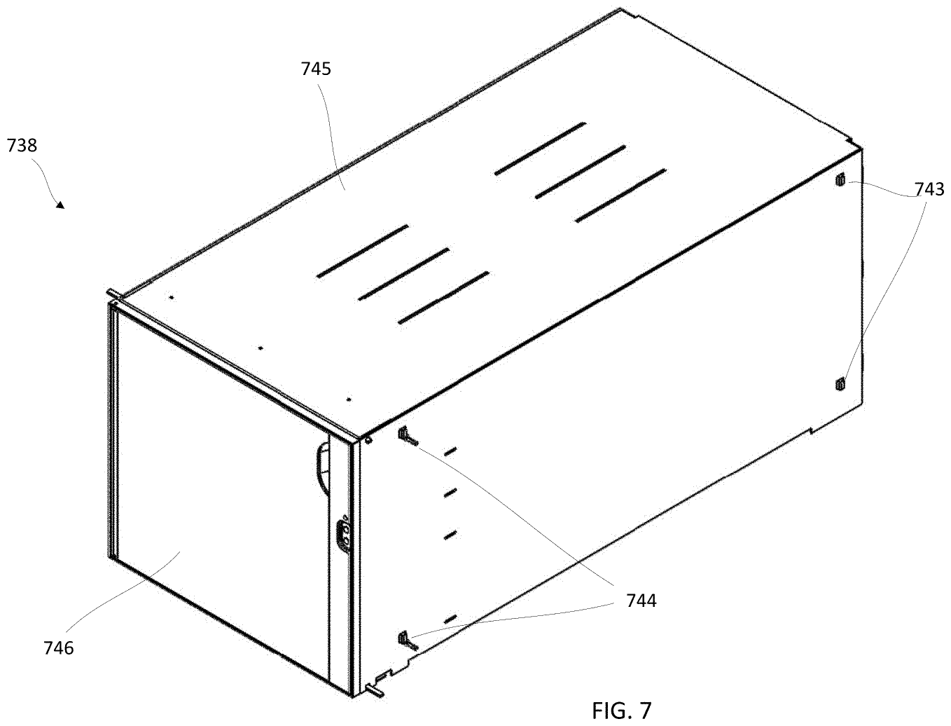

FIGS. 7-17 illustrate various different embodiments of a door storage unit. FIG. 7 illustrates a single wide by double deep storage unit 738 with a single door similar to door storage unit 138 in FIG. 1A. The storage unit 738 includes a bin or bucket 745 and a door 746. Hooks 743 can be used to releasably couple the storage unit 738 to a portion of the rack for which it is disposed. The storage unit 738 also includes manual override mechanisms that allow for the storage unit 738 to be manually unlocked if needed. FIG. 8 illustrates a two wide, single deep door storage unit 838 that includes a bin 845 and two doors 846 disposed side-by-side. FIGS. 9-11 illustrate a single wide, single deep door storage unit 938 that includes two doors 946 oriented horizontally and disposed with one above the other. As shown in FIGS. 10 and 11, a shelf 947 is disposed horizontally within the interior of the bin 945 to separate the bin 945 into two compartments, with each accessible with one of the doors 946.

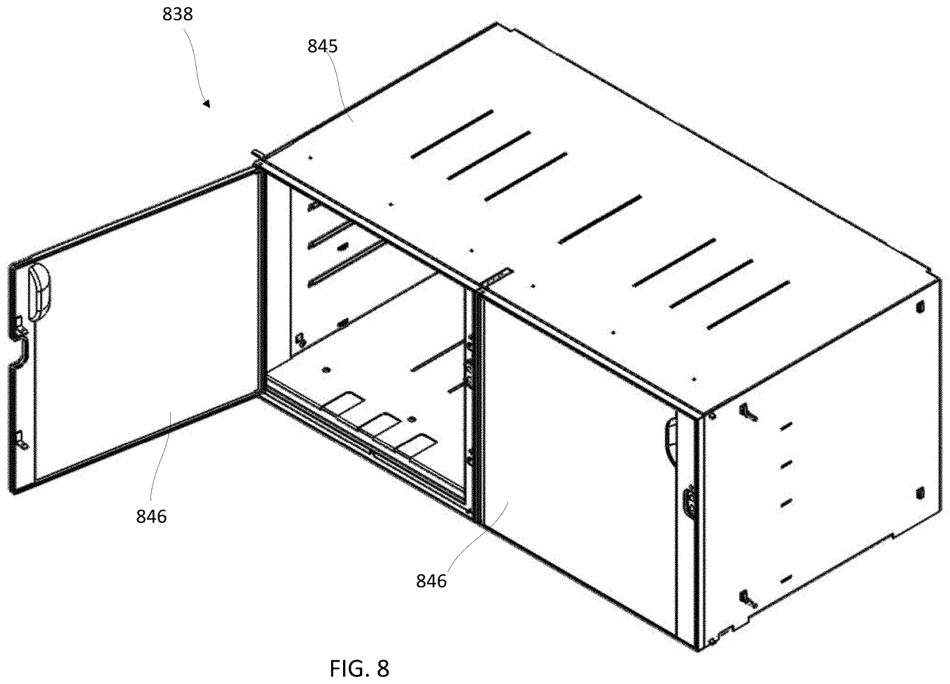

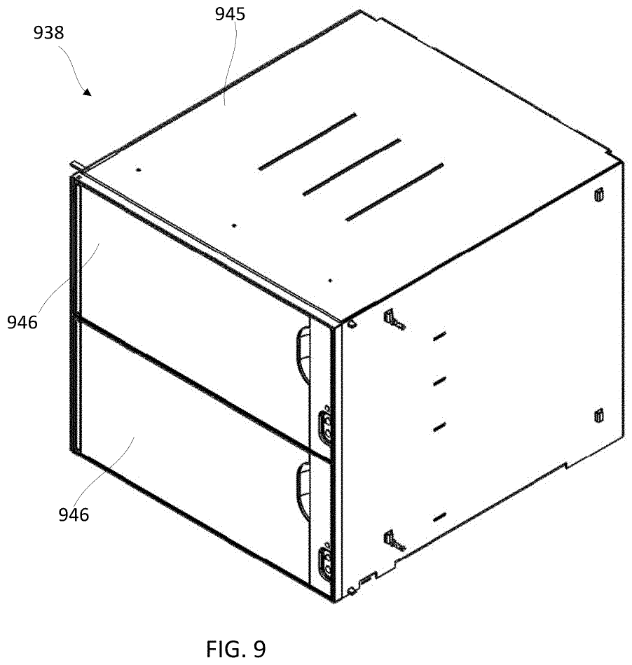

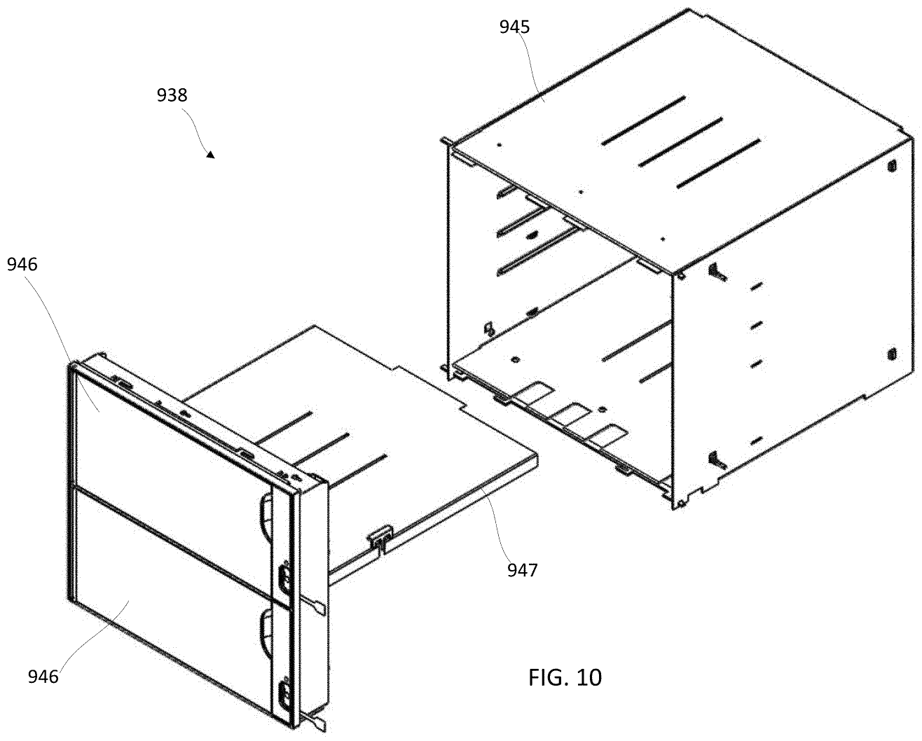

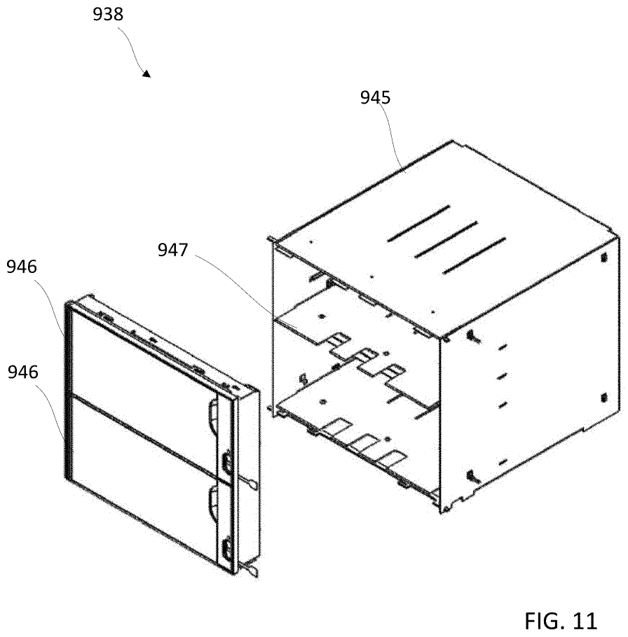

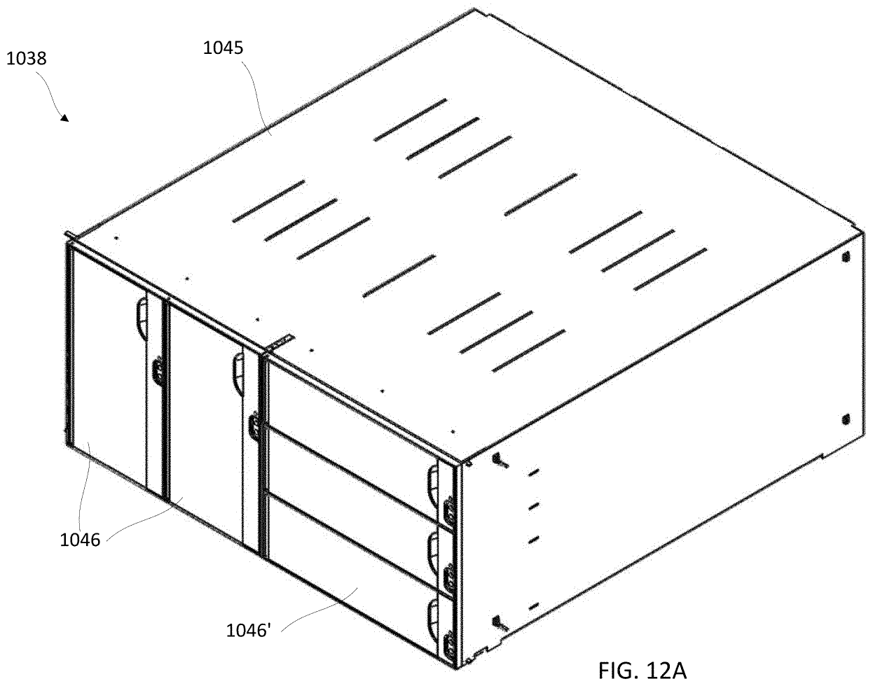

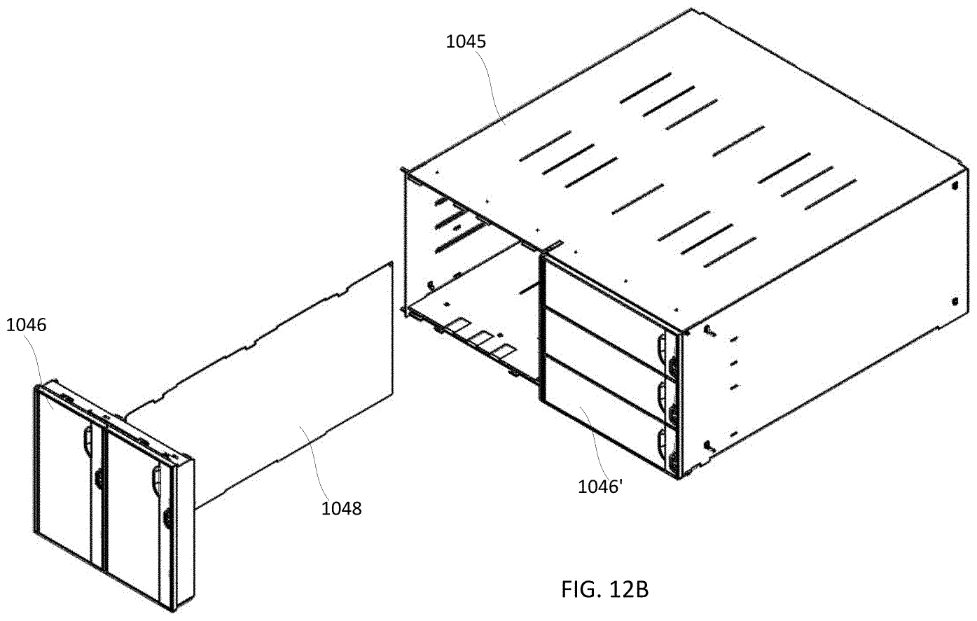

FIGS. 12A and 12B illustrate a two wide, two deep door storage unit 1038 that includes a bin 1045 and two doors 1046 oriented vertically and disposed side-by-side each other enclosing a left side of the bin 1045. The storage unit 1038 also includes three doors 1046′ oriented horizontally and disposed vertically relative to one another on a right side of the bin 1045. As shown in FIG. 12B, the left side of the bin 1045 can include a partition 10 and 11, a partition 1048 is disposed vertically within the interior of the bin 1045 to separate the left side of the bin 1045 into two compartments, with each accessible with one of the doors 1046. Although not shown. Additional partitions can be included on the right side of the bin 1045 and disposed horizontally to separate the right side of the bin 1038 into three compartments, each accessible with one of the doors 1046′.

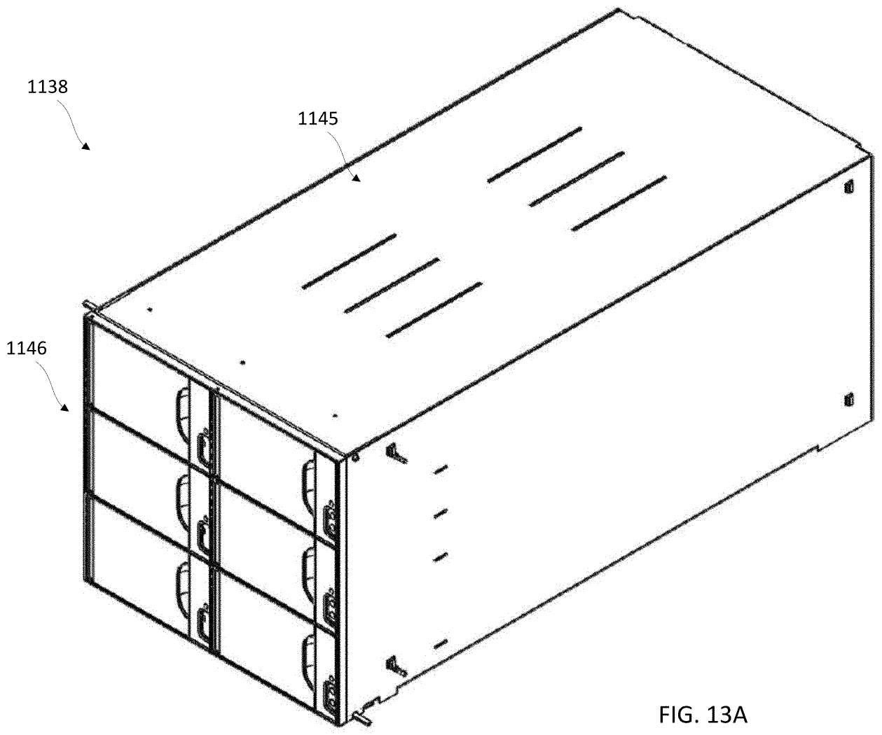

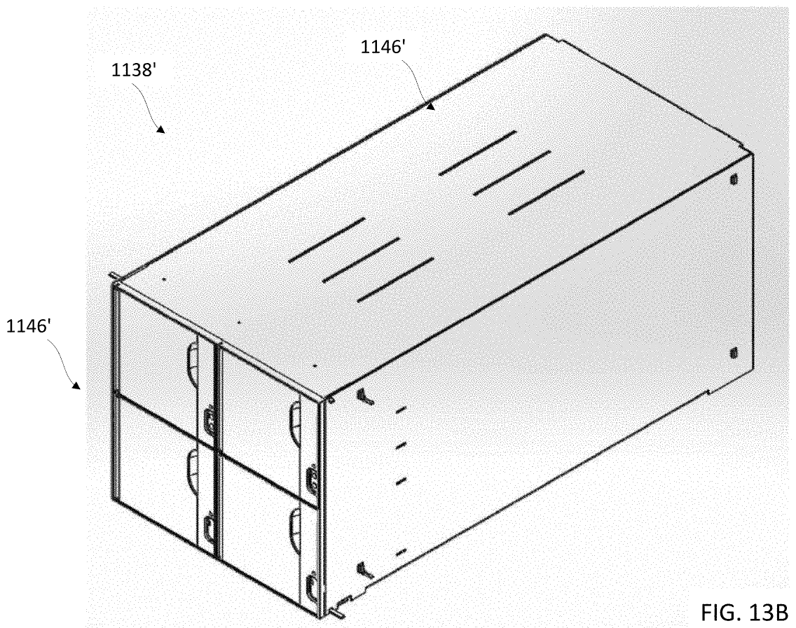

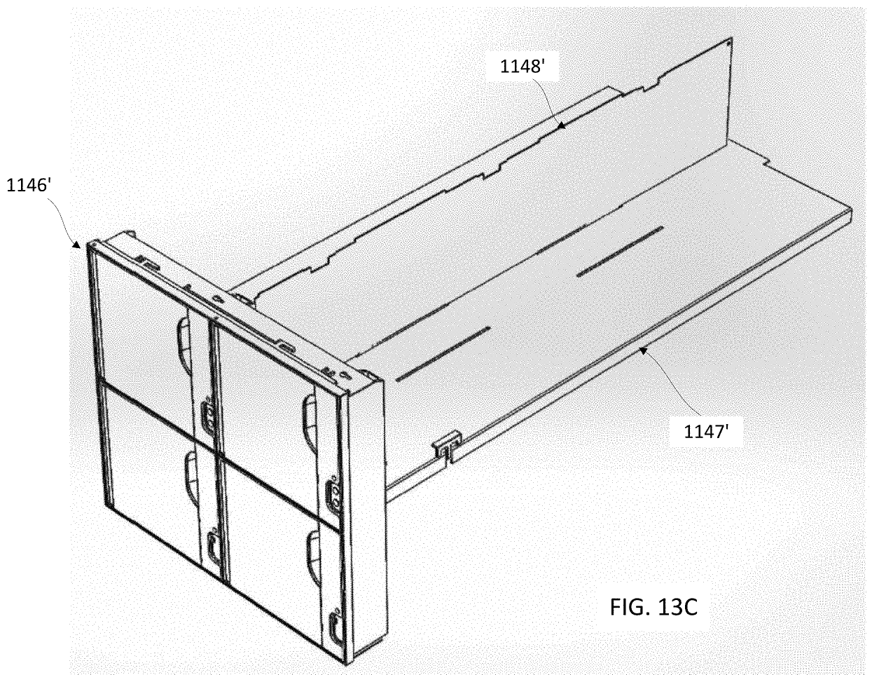

FIG. 13A illustrates a one wide by two deep door storage unit 1138 that includes a bin 1145 and six doors 1146. As with the previous embodiments, partitions can be included to separate the interior of the bin 1145. FIGS. 13B and 13C illustrate another embodiment of a one wide by two deep door storage unit 1138′ that includes a bin 1145′ and four doors 1146′. As shown in FIG. 13C, a shelf 1147′ and a partition 1448′ can be included to separate the interior of the bin 1145′.

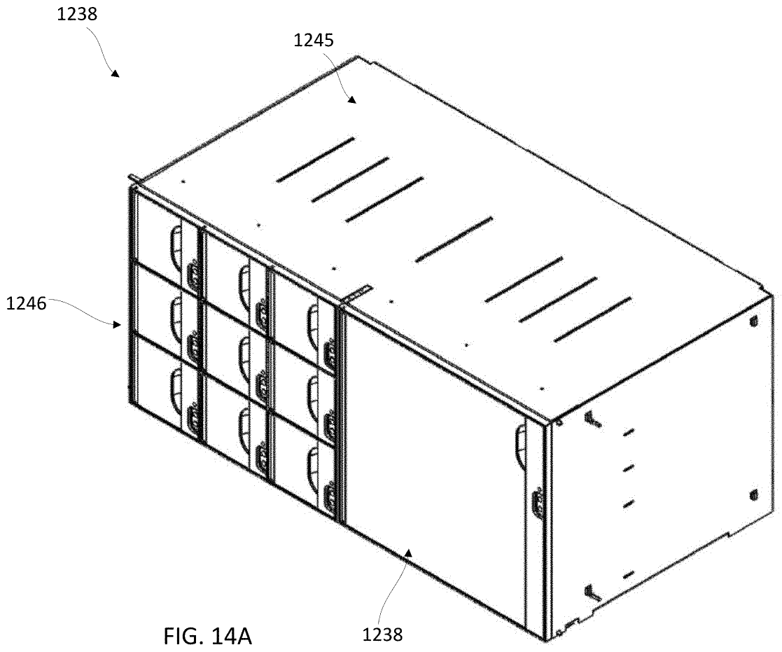

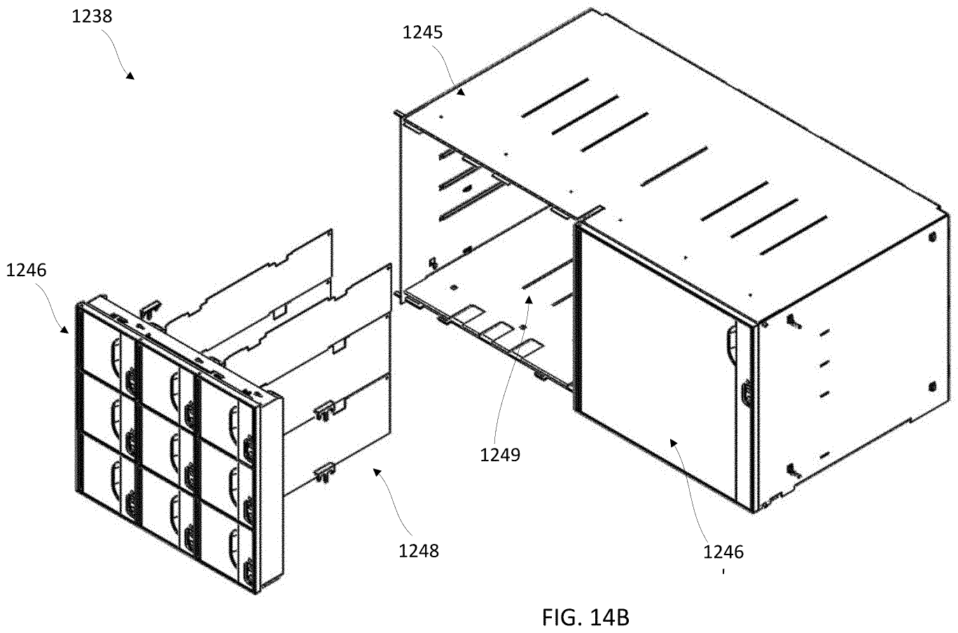

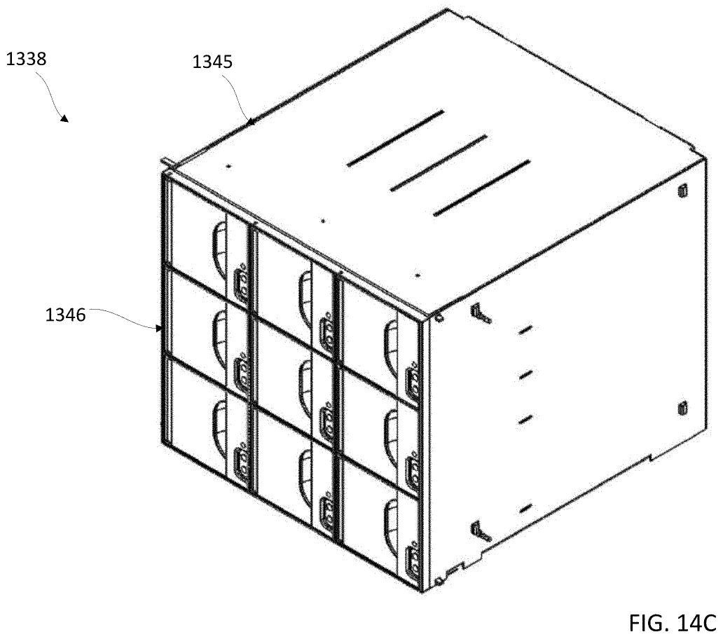

FIGS. 14A and 14B illustrate a two wide by one deep door storage unit 1238 that includes a bin 1245, nine doors 1246 on a left side of the bin 1245 and a single door 1246′ on the right side of the bin 1245. As shown in FIG. 14B, three partitions 1248 are disposed in the interior of the left side of the bin 1245 to separate the interior of the left side of the bin 1245. For example, the partitions 1248 can be inserted into slots 1249 within the interior of the bin 1245. Additional partitions can be disposed to separate the interior of the bin even further if desired. FIG. 14C illustrates a single wide by single deep door storage unit 1338 that includes a bin 1345 and nine doors 1346.

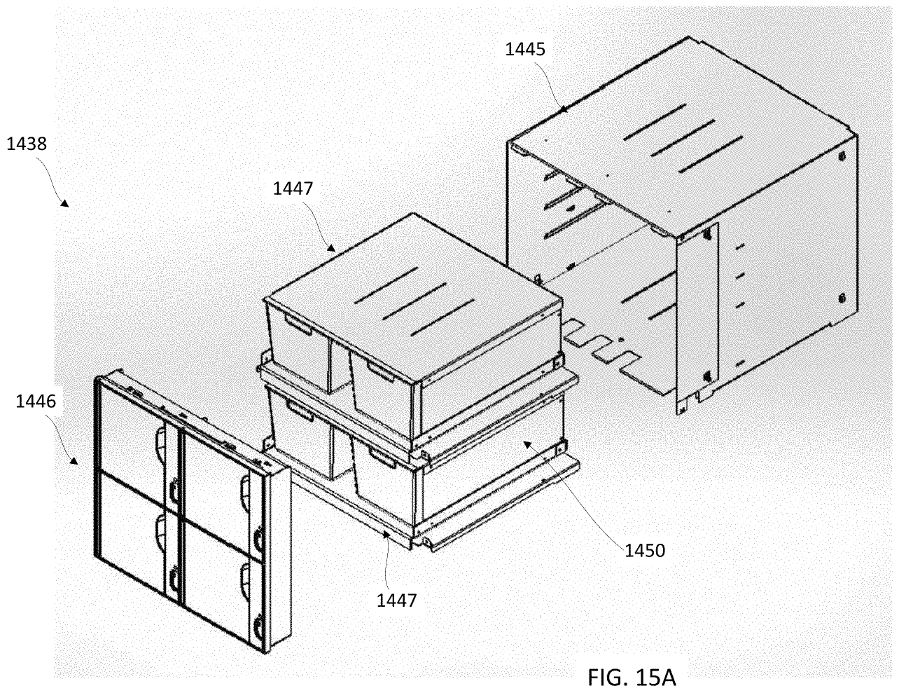

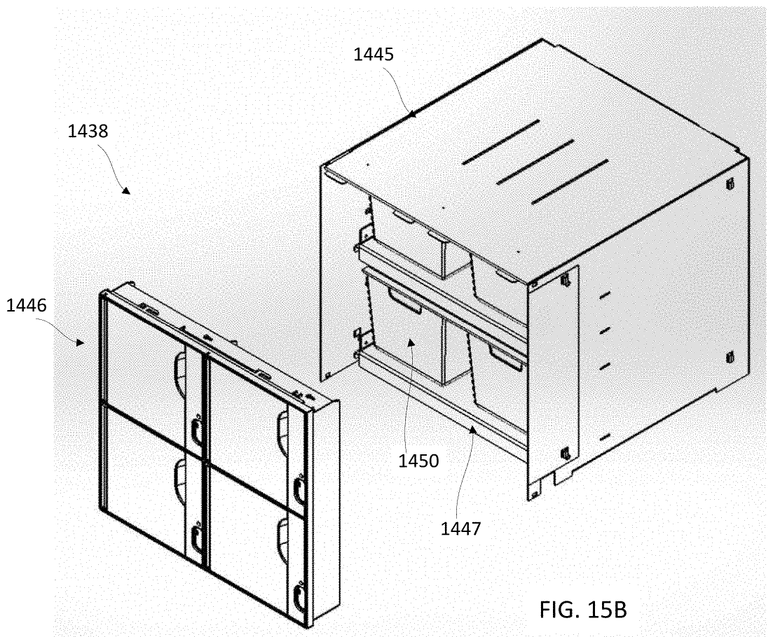

FIGS. 15A and 15B illustrate scale door storage unit 1438. The storage unit 1438 can be monitored by weight of the contents within the storage unit. For example, a sensor(s) such as, for example, a wishbone load cell, can be disposed on or in a shelf of the storage unit 1438 can be disposed within the storage unit 1438 and can communicate with the control unit (not shown) for the storage system. In this embodiment, the storage unit 1438 is one wide by one deep, and includes a bin 1445 and four doors 1446. Shelves 1447 are included to separate the top and bottom interior portions of the bin 1445, which can include sensors to monitor the weight of the contents within the storage unit 1438. Four removable trays 1450 are disposed on the shelves 1447 and can be used to contain and store items.

FIGS. 16A-16C illustrate another embodiment of a scale door storage unit 1538. In this embodiment, the storage unit 1538 is two wide by one deep, and includes a bin 1545 and two doors 1546 (the door on the right side of the bin 1545 is removed for illustration purposes). Shelves 1547 are included to separate the interior of the bin 1545 and include sensors as described above for storage unit 1538. Removable trays 1550 can be disposed on the shelves 1547 and can be used to contain and store items.

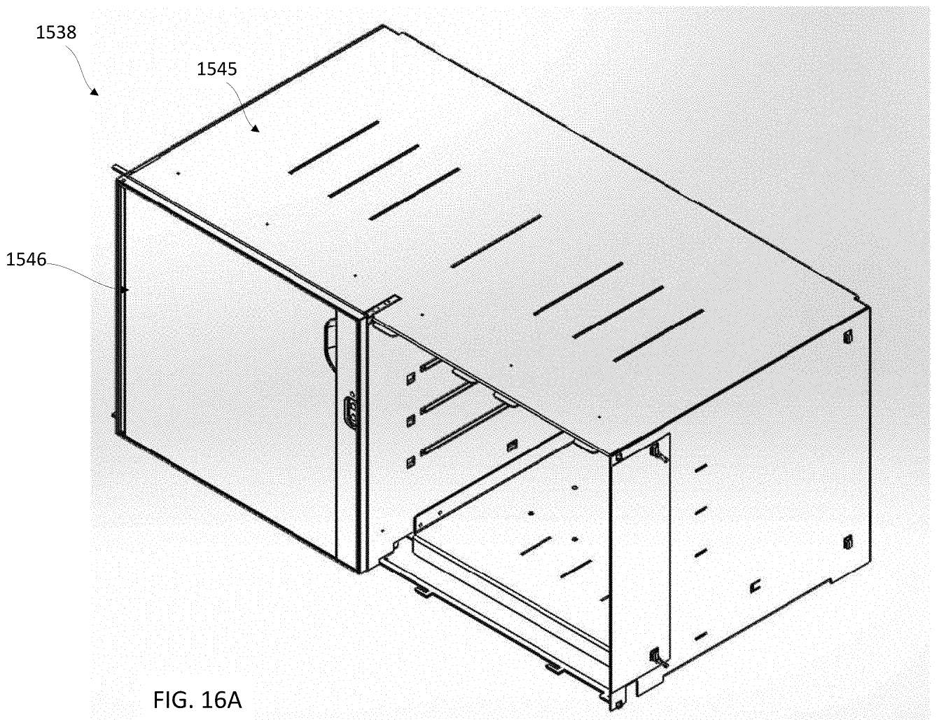

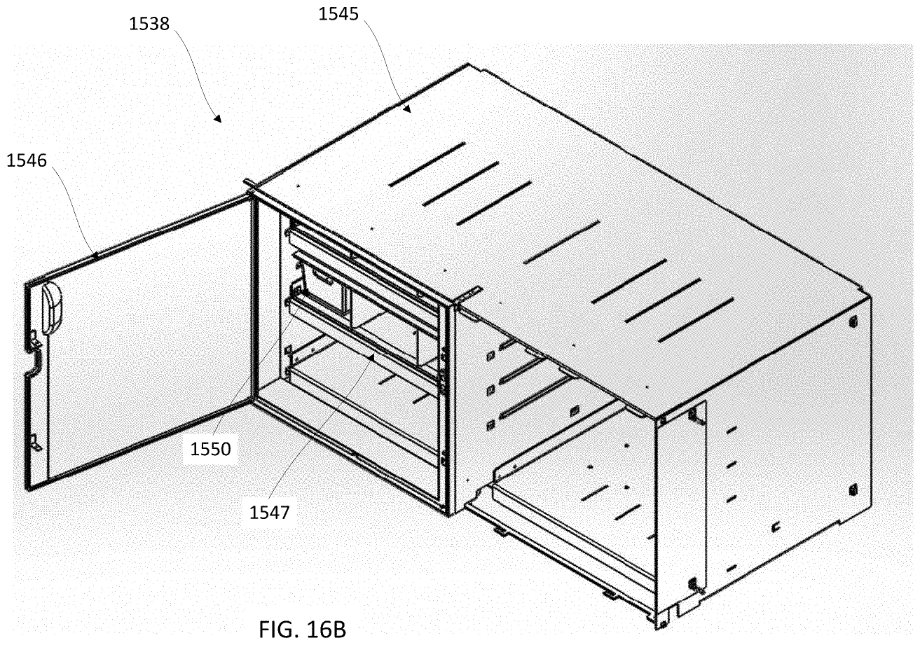

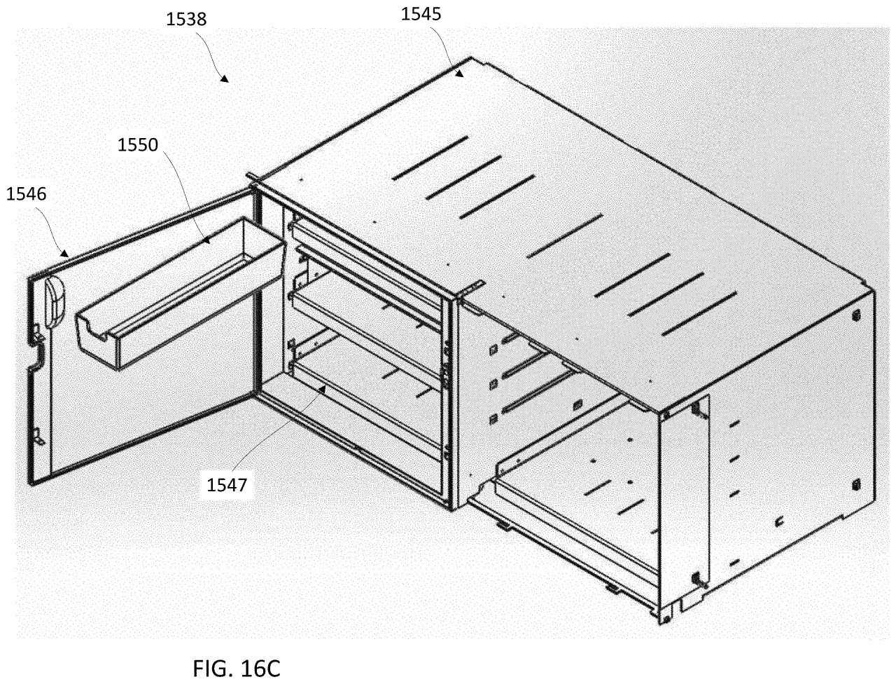

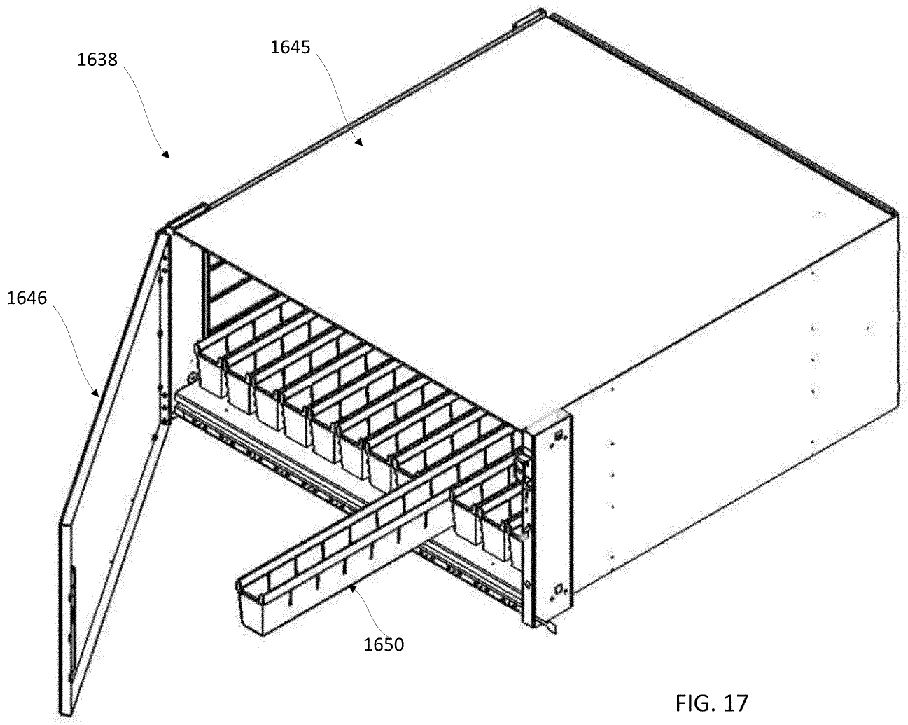

FIG. 17 illustrates a storage unit 1638 that is two wide by two deep, and includes a bin 1645 and a single door 1646. Multiple removable trays 1650 can be disposed within the bin 1645 and can be used to contain and store items.

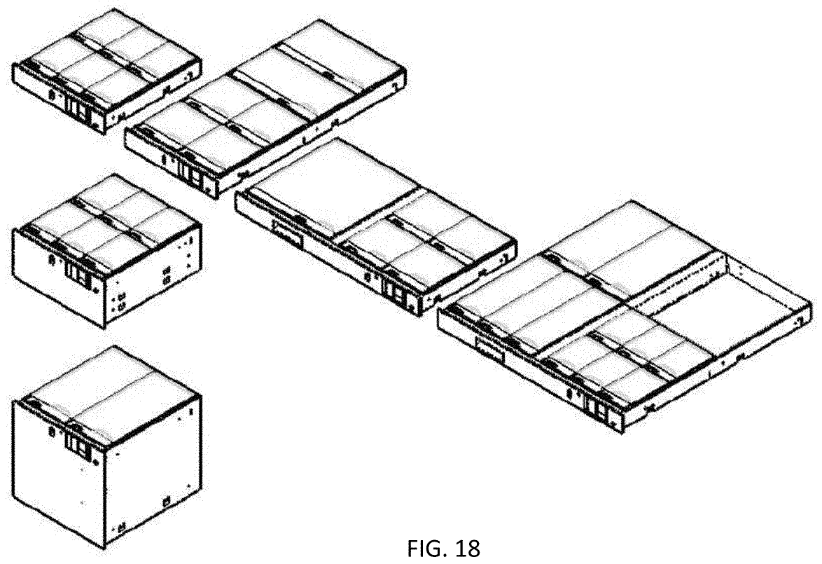

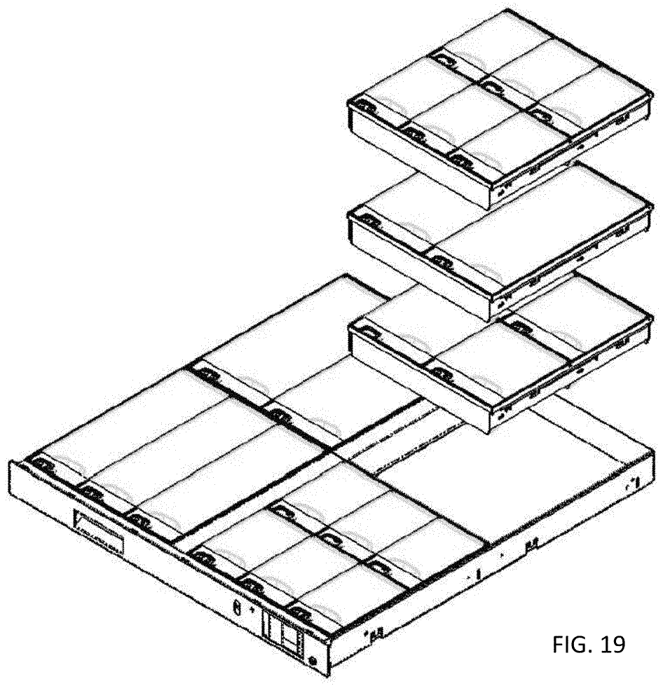

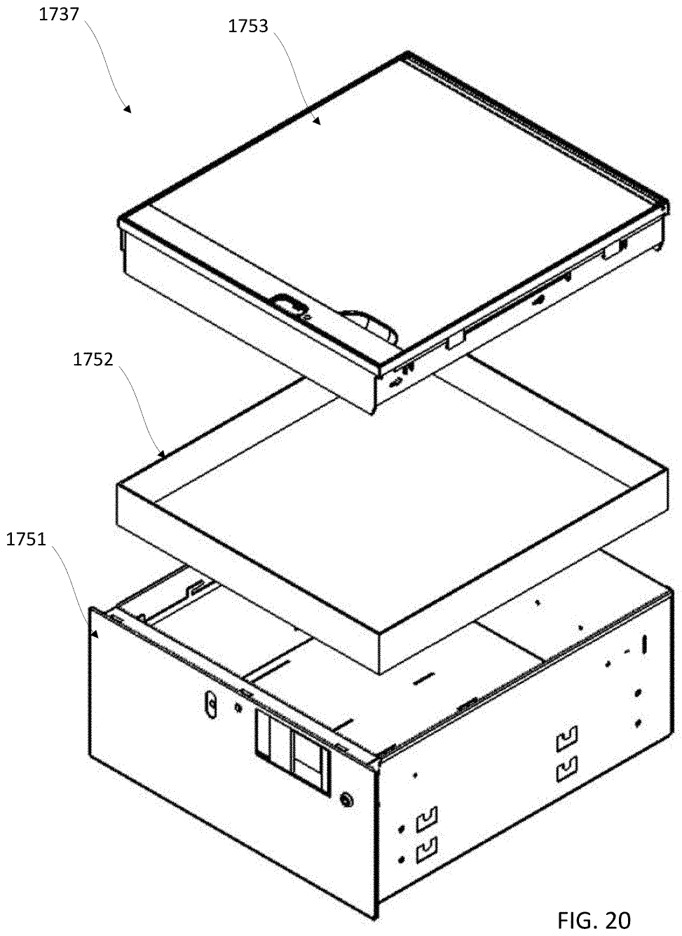

FIGS. 18 and 19 illustrate various different embodiments of a covered drawer storage unit. The front face of the drawers can include a handle and a light to indicate whether the drawer is locked or unlocked. FIG. 20 illustrates a scale drawer storage unit 1737. In this embodiment the storage unit 1737 includes a drawer bin 1751, a tray 1752 and a drawer cover 1753. Electronics and a load cell(s) can be disposed under the tray and used to monitor the weight of the content in the drawer bin 1751.

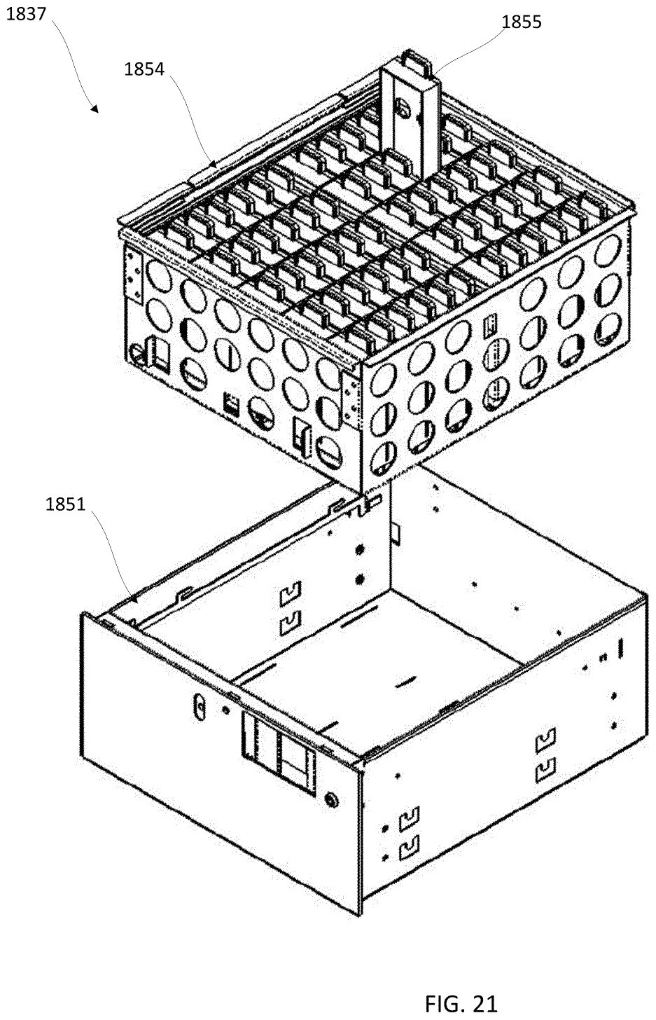

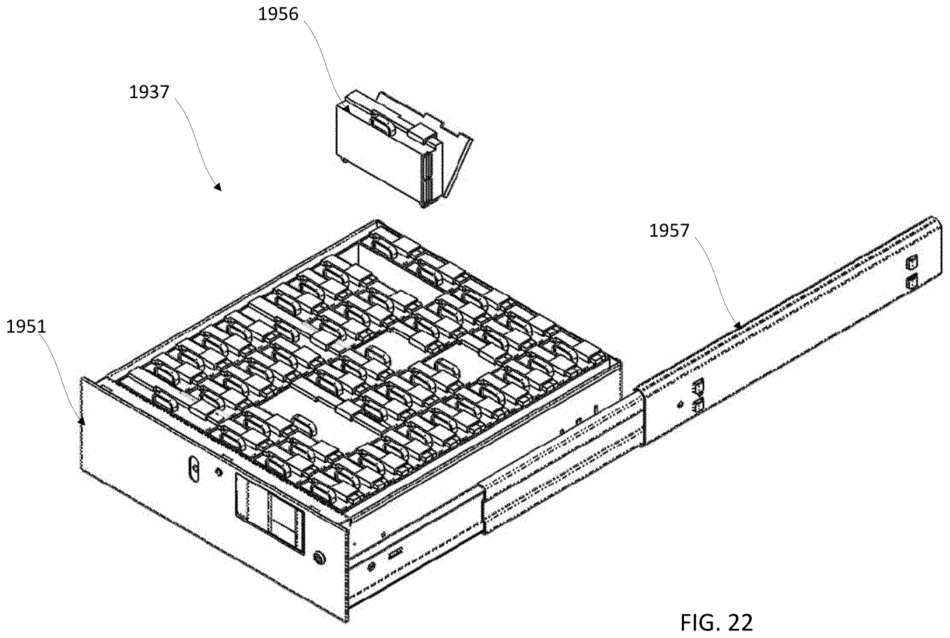

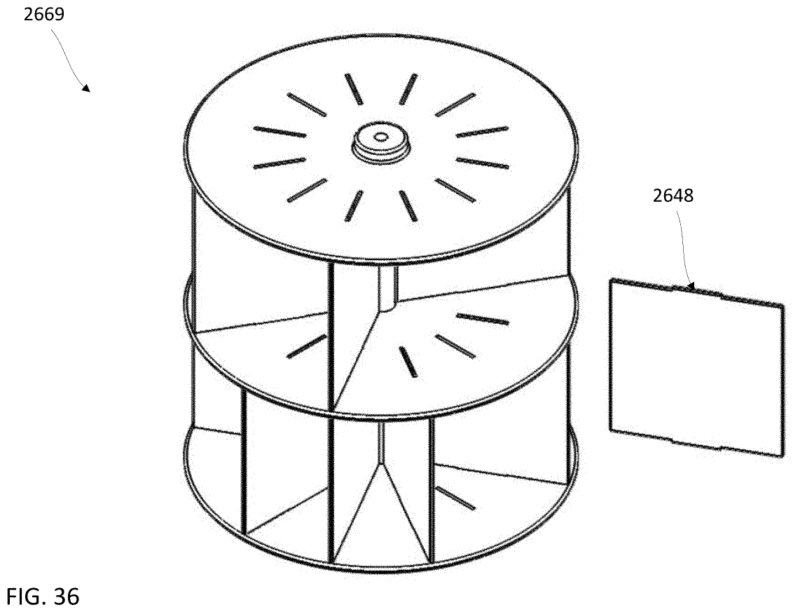

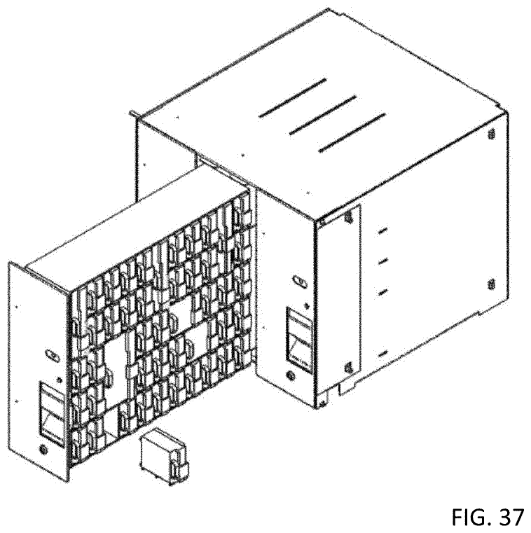

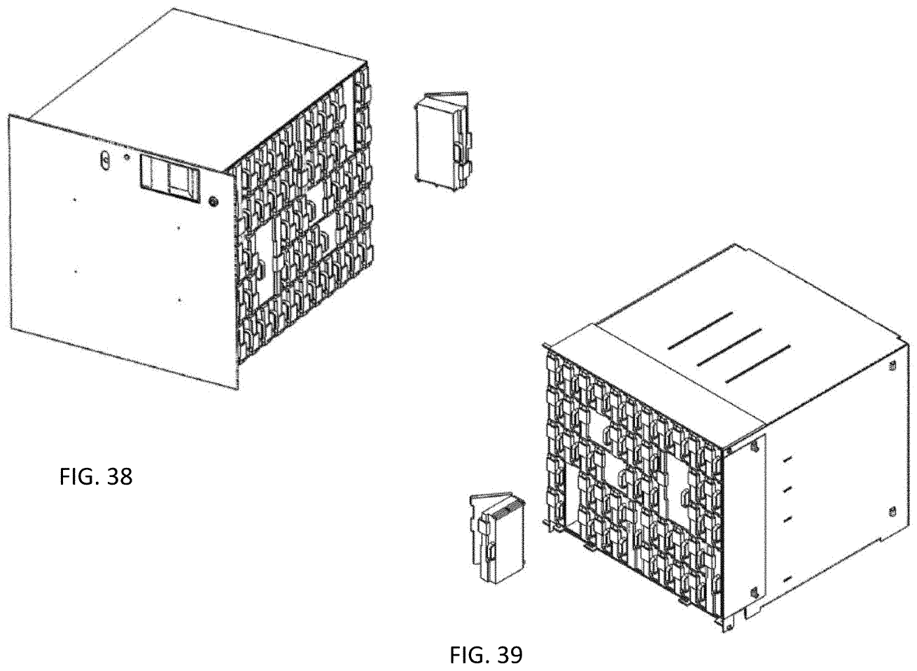

FIG. 21 illustrates a drawer storage unit 1837 that includes a drawer bin 1851 and a drawer tray 1854. The tray 1854 can contain removable cartridges 1855. FIG. 22 illustrates a drawer storage unit 1937 that includes a drawer bin 1951 and a drawer tray (not shown) that can contain storage cassettes 1956. Also shown in FIG. 22 is a rail of the drawer mechanism 1957 for slidably opening the storage unit 1937. FIGS. 37-39 illustrate various different embodiments of a drawer storage unit that can include cartridges or cassettes similar to drawer units 1837 and 1839.

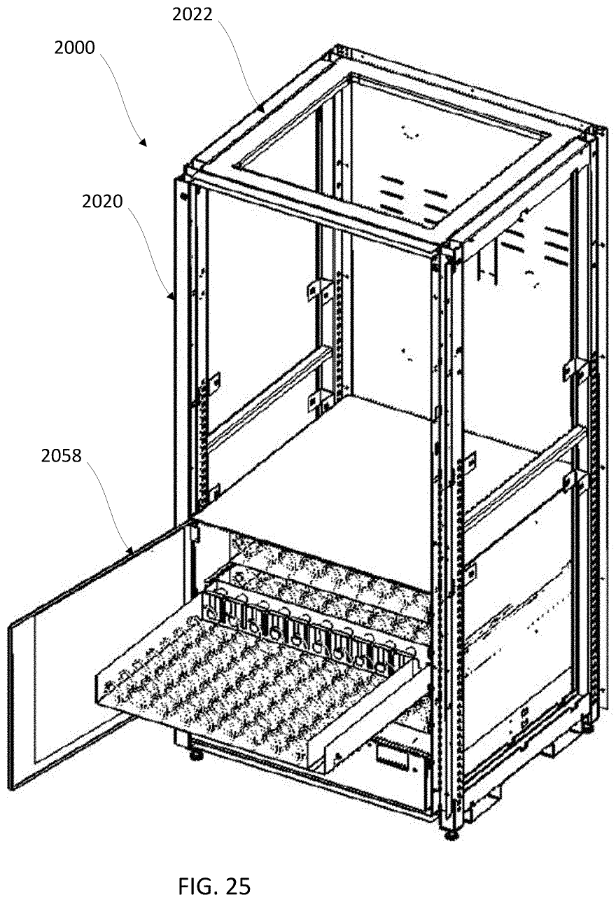

FIGS. 23-29 illustrate various different embodiments of a storage cabinet and/or storage unit. FIGS. 23-25 illustrate a portion of a storage system 2000 that includes a cabinet 2020 with a rack 2022, a helix coil storage unit 2058 and a drawer storage unit 2037. Although not shown, the storage system 2000 can include a control rack and control unit and other storage units can be disposed within the rack 2022.

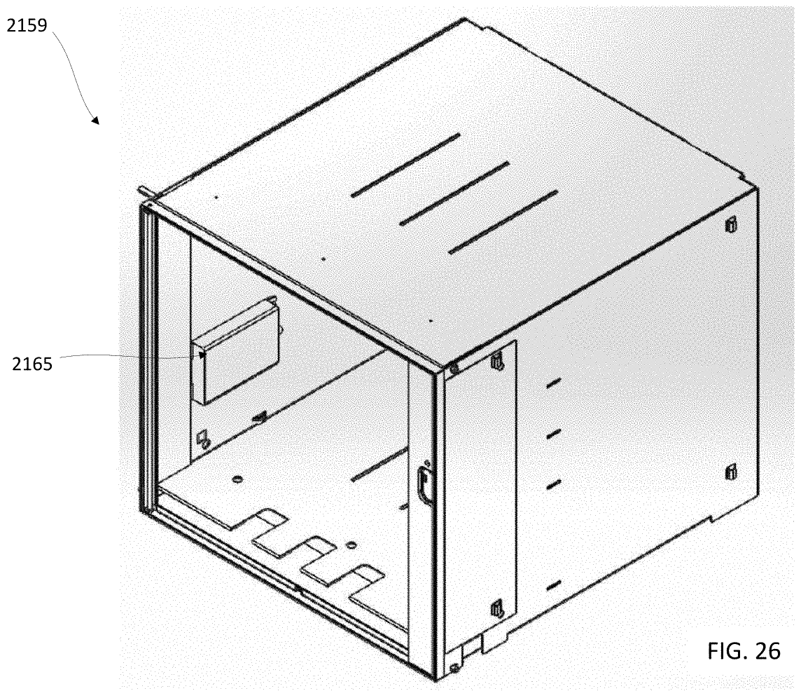

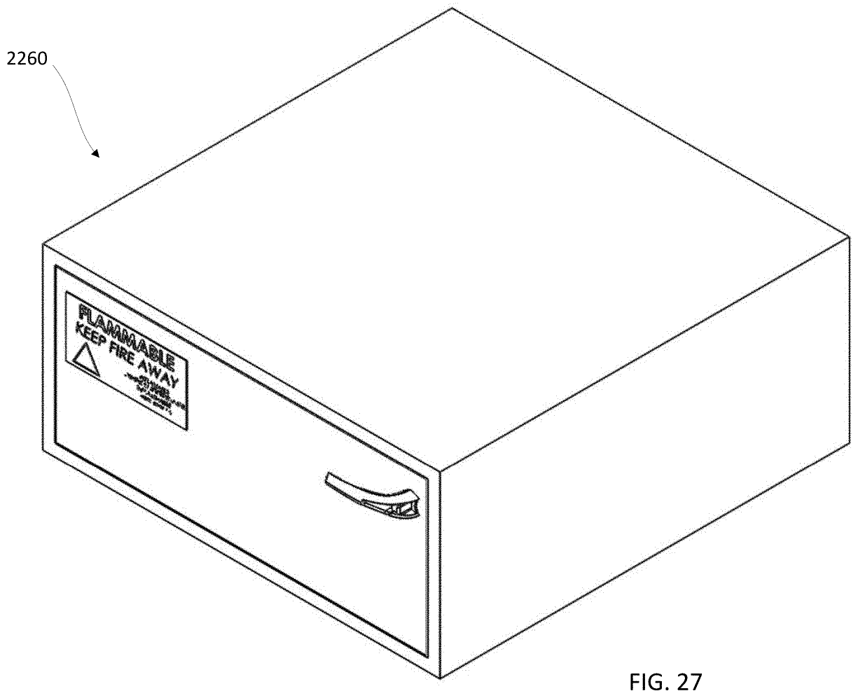

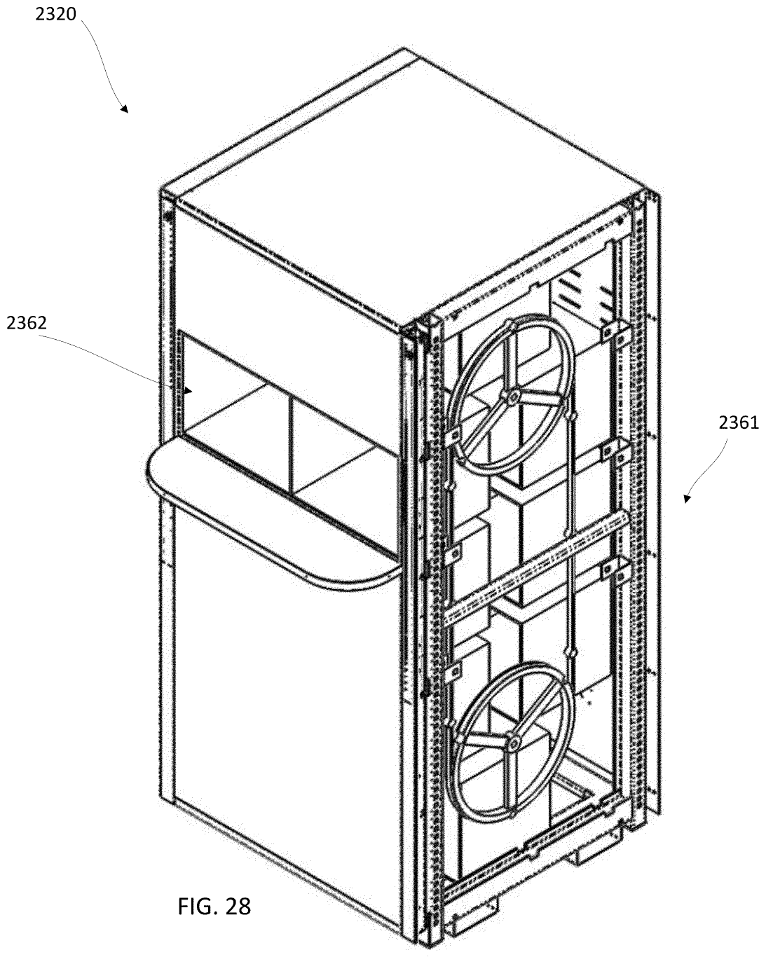

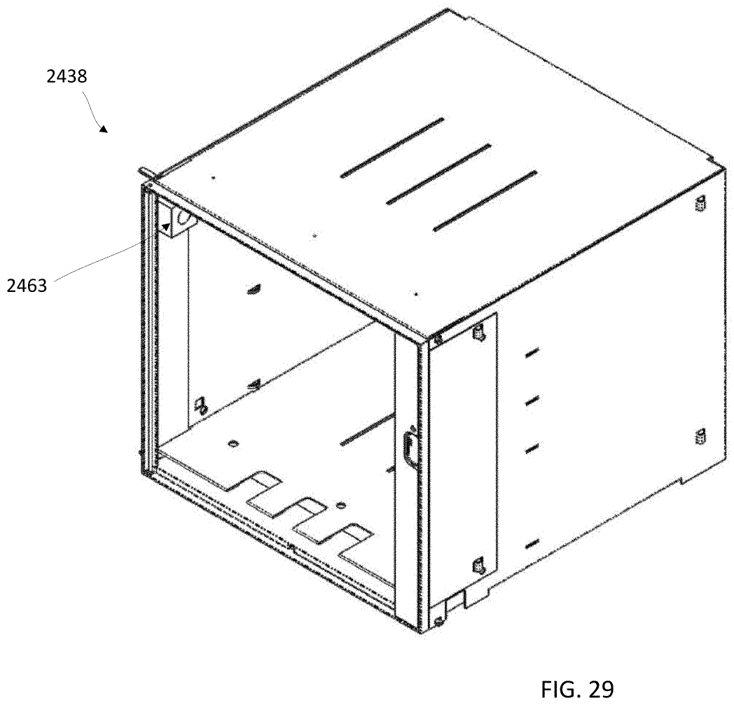

FIG. 26 illustrates an embodiment a storage unit 2159 that includes a radio-frequency identification (RFID) system 2165. In this embodiment, the contents of the storage unit can be monitored by tracking the serial number disposed on the stored items. FIG. 27 illustrates an embodiment of storage unit 2260 that can be used to store flammable and/or other hazardous materials. The bin, door(s) and other components of the storage unit 2260 can be formed with, for example, metal, plastic or other suitable material. FIG. 28 illustrates an embodiment of storage cabinet 2320 that includes a vertical lift system 2361 that can be used to retrieve stored items within the storage cabinet 2320 and place at a window 2362 accessible to a user. FIG. 29 illustrates an embodiment of storage unit 2438 that includes an optical tracking system 2463 that can be used to monitor the removal of items within the storage unit 2438.

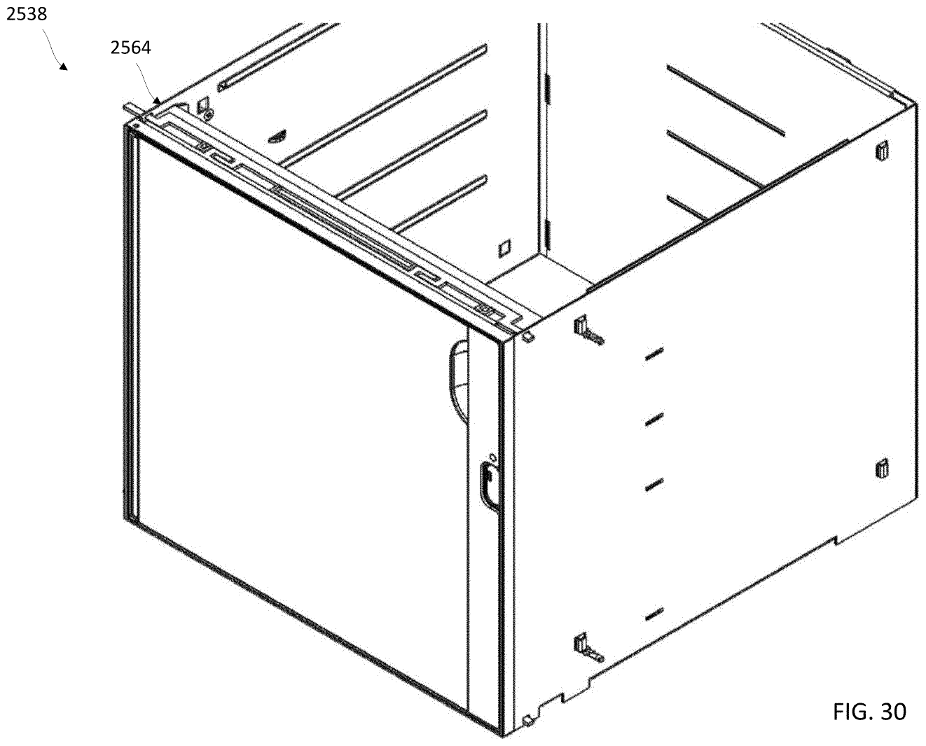

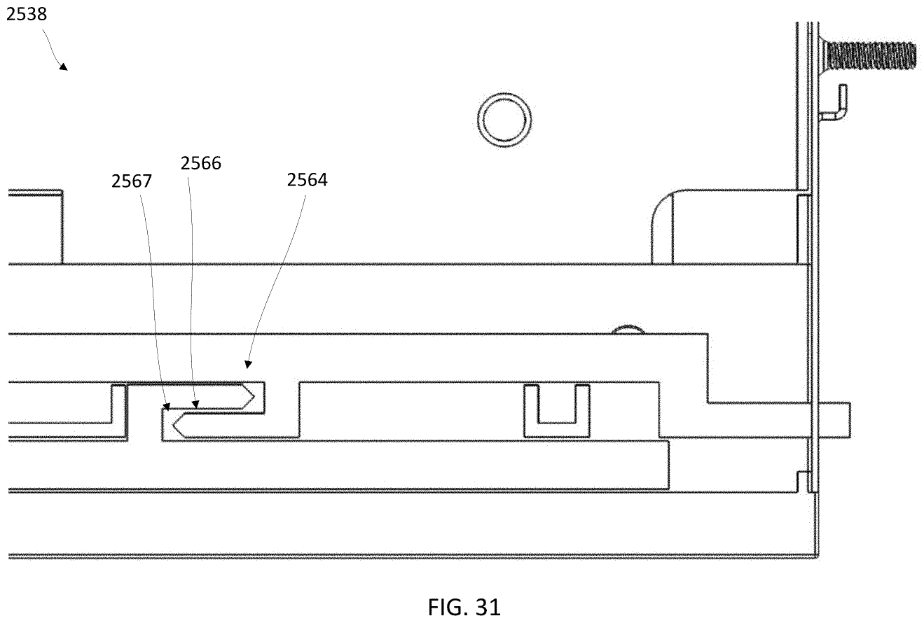

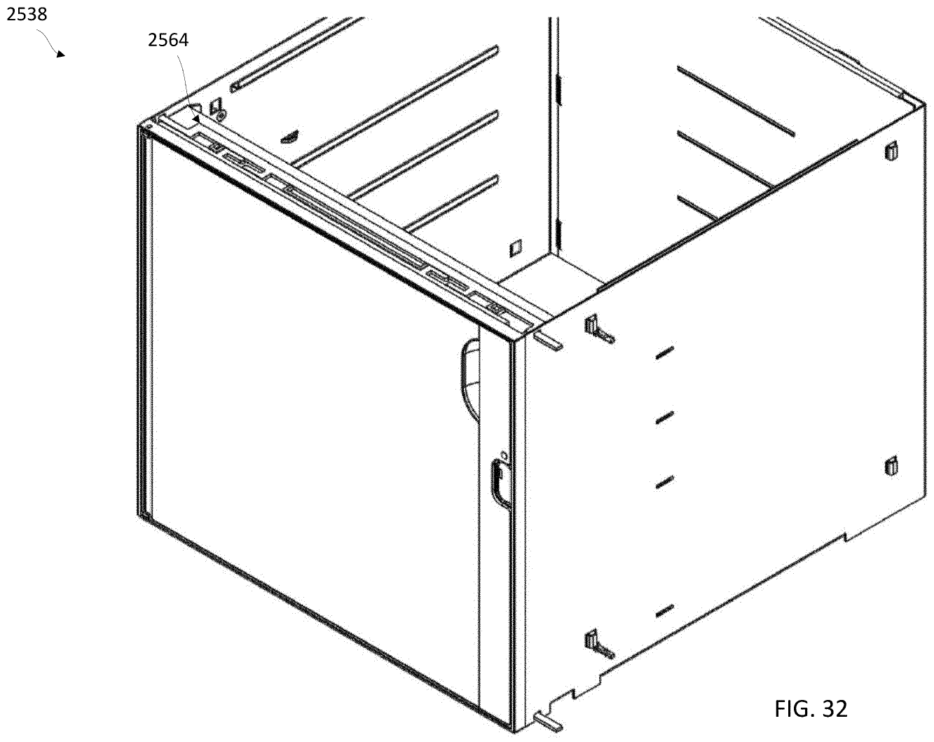

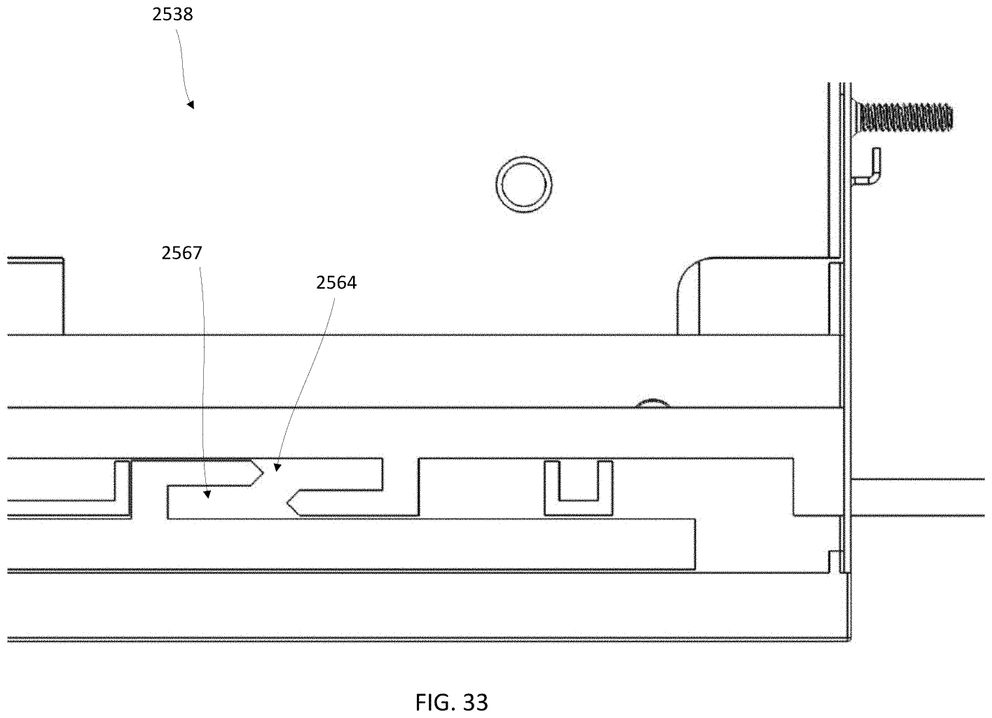

FIGS. 30-33 illustrate a storage unit 2538 and a locking mechanism 2564. FIG. 30 shows the storage unit 2538 with the lock mechanism in a locked position and FIG. 31 is an enlarged view of a top portion of the storage unit 2538 showing the locked position of the lock mechanism 2564. As best shown in FIG. 31, an arm 2566 of the lock mechanism 2564 is engaged within a recess 2567 of the lock mechanism 2564. FIG. 32 shows the storage unit 2538 with the lock mechanism in an unlocked position and FIG. 33 is an enlarged view of a top portion of the storage unit 2538 showing the unlocked position of the lock mechanism 2564. Here the arm 2566 is disengaged from the recess 2567.

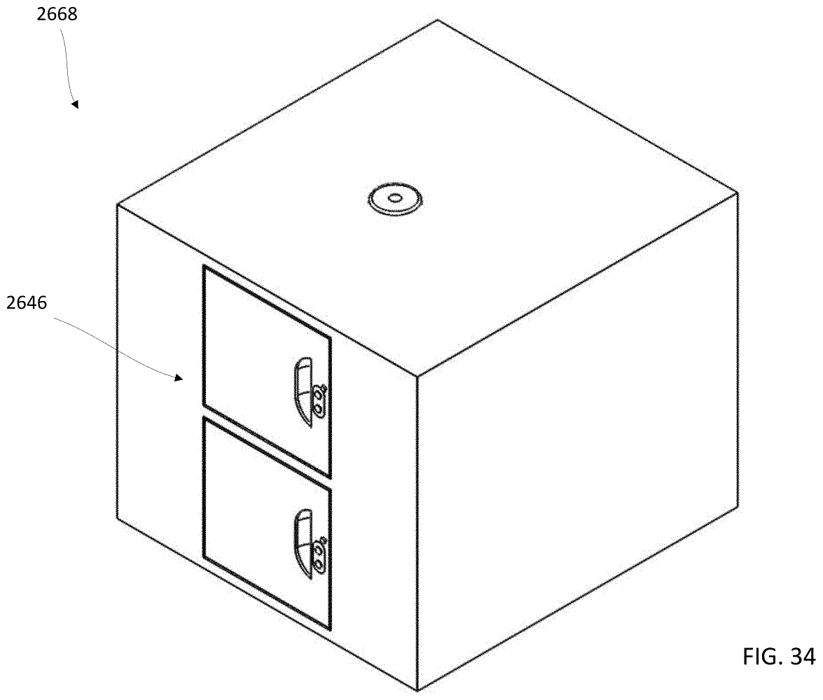

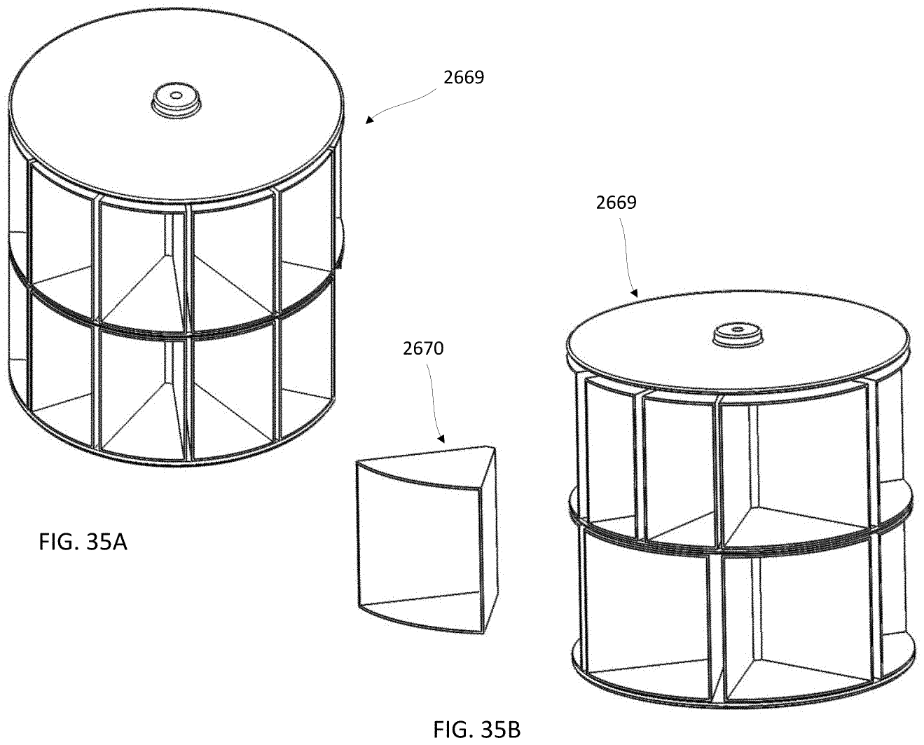

FIGS. 34-36 illustrate a carousel type storage unit 2668. In this embodiment the storage unit 2668 includes a parts carousel 2669 (see FIGS. 35A-36) that is accessible through doors 2646. The parts carousel 2669 can include partitions 2648 and/or removable storage cartons 2670.

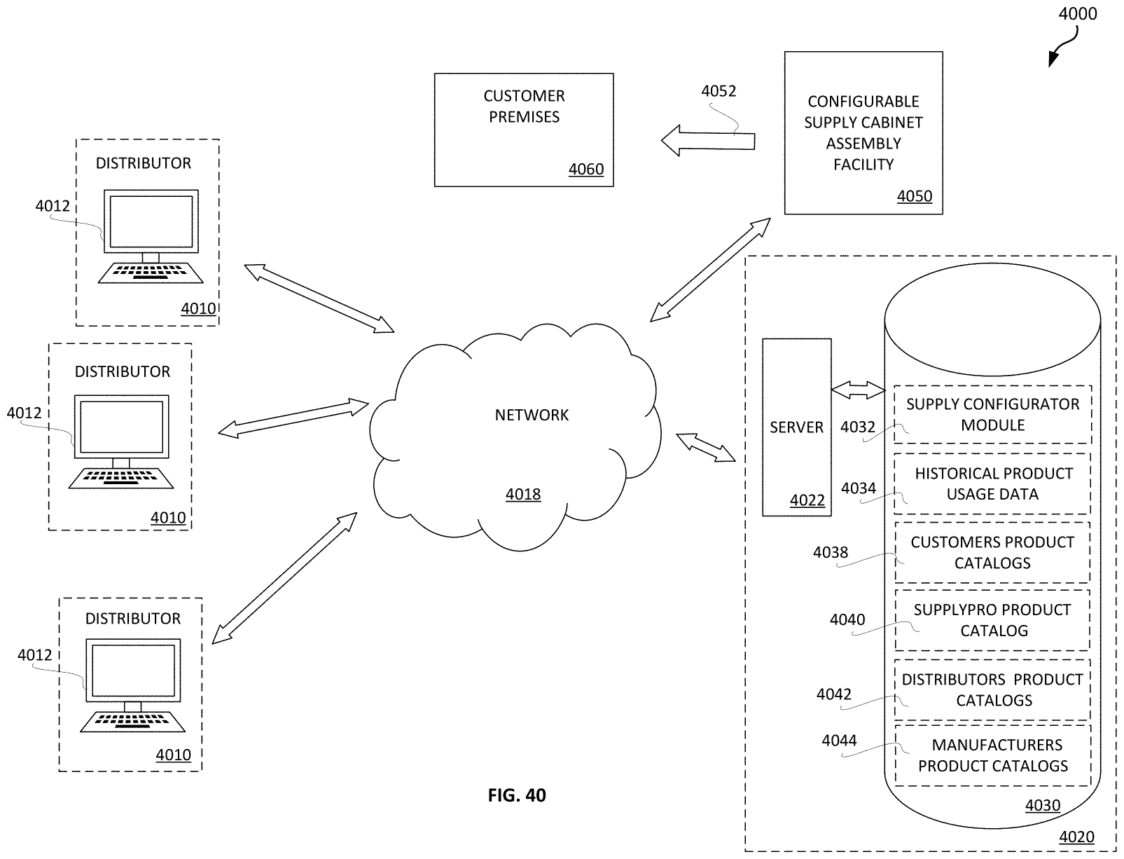

Attention is now directed to FIG. 40, which illustrates a system 4000 for facilitating the design, configuration and assembly of configurable supply cabinets in accordance with the disclosure. As shown, the system includes a plurality of distributors 4010 engaged in providing tools, supplies and the like to their customers, which are typically manufacturing or other industrial enterprises. The distributors 4010 may also receive orders from their customers for configurable supply cabinets of the type described herein for containing and dispensing these supplies and otherwise implementing inventory control functions. One of more user electronic devices 4012 (e.g., smartphones, desktop computers, laptop computers, tablet computers) operated by each distributor 4010 are in communication over a network 4018 with a server complex 4020 having at least one server 4022 and memory storage 4030.

The at least one server 4022 is configured to facilitate the design and configuration of configurable supply cabinet systems ordered or otherwise requested by distributors 4010 on behalf of their customers. The memory storage 4030 may store a supply configurator module 4032 comprised of program instructions executed by the server 4022 for the purpose of developing optimal supply cabinet configurations in the manner described hereinafter. In this sense an optimal supply cabinet configuration could comprise a supply cabinet configuration which is capable of storing a particular set of supplies or parts in such a way as to minimize cost, floor footprint, cubic volume, or other user-specified parameters. The memory 4030 may further include historical usage data 4034 relating to the usage of parts and/or supplies by various customers. As is discussed below, such historical usage data, along with anticipated re-stocking frequency information, is utilized by the supply configurator module 4032 in determining optimal supply cabinet configurations for customers of the distributors 4010. The optimal supply cabinet configurations determined by the supply configurator module 4032 may then be communicated to an assembly facility 4050 operative to assemble configurable supply cabinet systems using, for example, the supply cabinet modules, drawers and other components described above with reference to FIGS. 1-39. The supply cabinet systems produced at the assembly facility 4050 may then be shipped 4052 to customer premises 4060 or otherwise provided to the distributors 4012 for distribution to their customers.

Distributors may provide specifications for configurable supply cabinet systems to the server complex 4020 on behalf of their customers. In other embodiment end users of the configurable supply cabinet systems may contract directly with an operator of the supply configurator module 4032 and the configurable supply cabinet assembly facility 4050 (the “system operator”) and place direct orders for configurable supply cabinet systems.

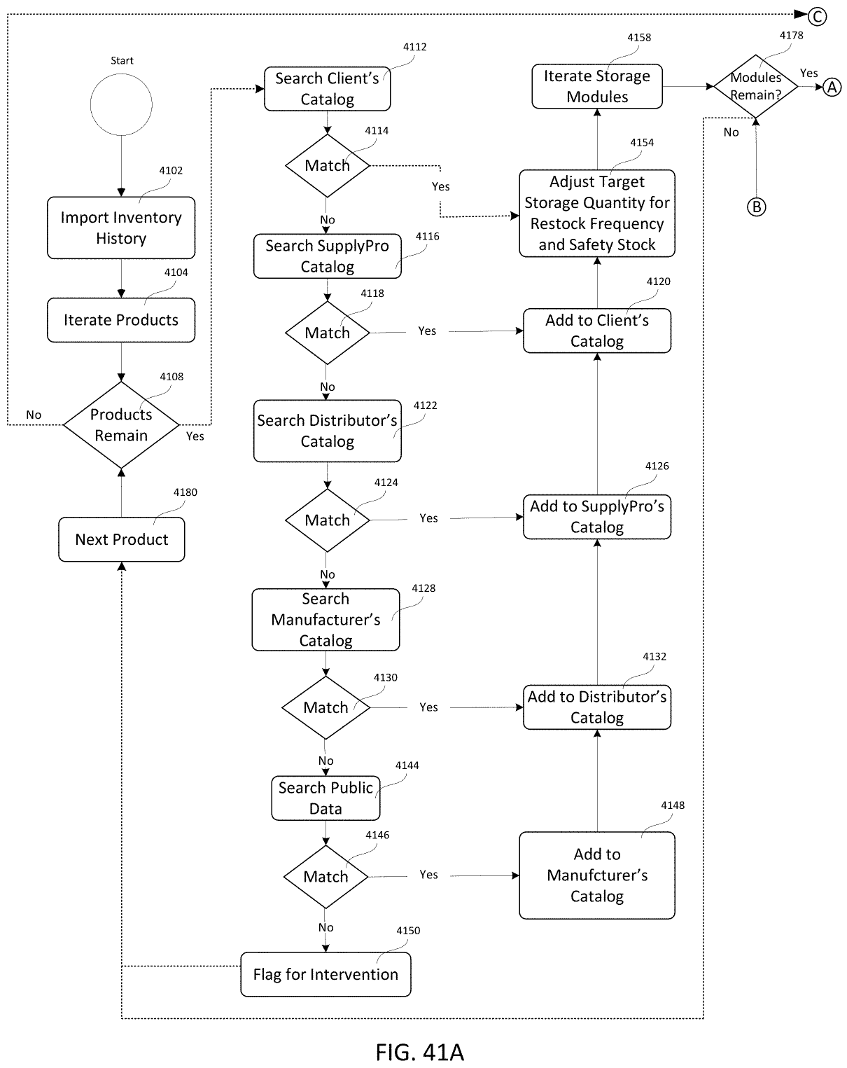

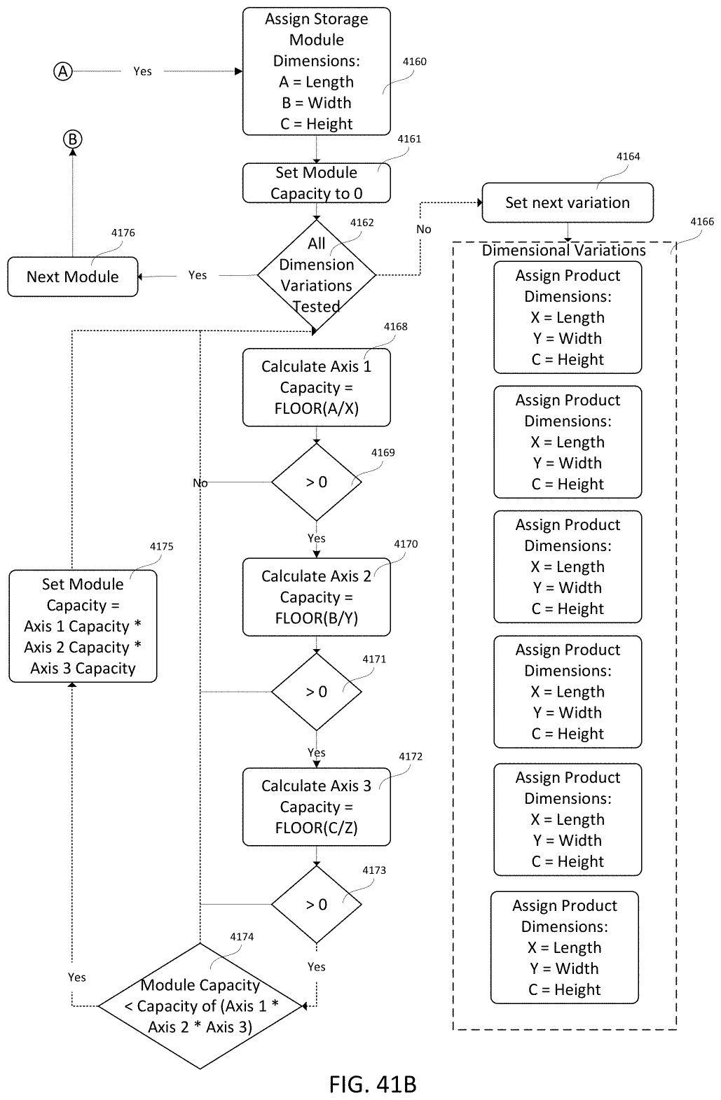

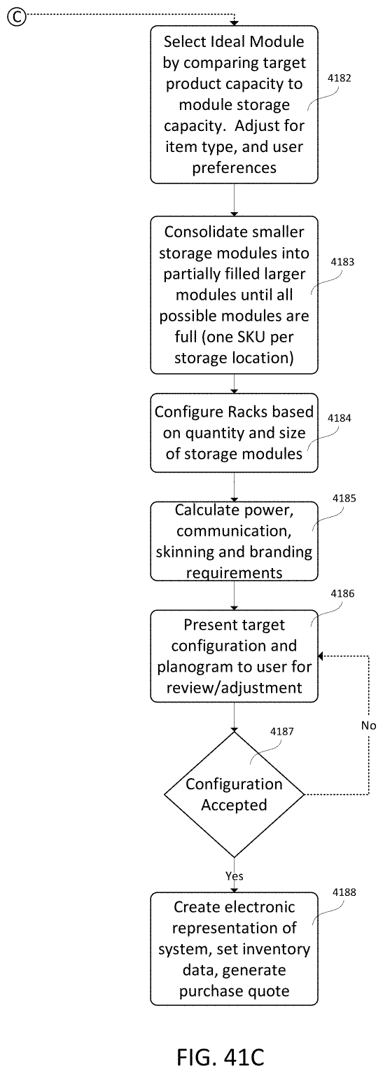

Attention is directed to FIGS. 41A-41C, which collectively illustrate a flowchart representative of a computer-implemented process 4100 for configuring a supply cabinet system in accordance with the disclosure. In one embodiment the configuration process 4100 illustrated by FIGS. 41A-41C is performed by the supply configurator module 4032, which executes on the server 4022 or other computing infrastructure of the server complex 4020.

In one embodiment the supply configurator module 4032 analyzes indirect materials inventory data and uses advanced algorithms based on historical data from known inventory transactions to provide supply cabinet system configuration recommendations to optimize inventory control. The supply configurator module 4032 may also provide tools to allow for changes to be made based on the user's own experience and insight.

Referring now to FIG. 41A, the supply configurator module 4032 pulls in data relating to the history of utilization of a particular item or product capable of being dispensed from a supply cabinet (stage 4102). This product utilization data can be obtained in various ways such as, for example, being pulled from an enterprise resource planning (ERP) feed, a distributor 4010, or simply a file containing a listing of items which a given customer entity is using or buying. This data could generally include, typically as a function of department or particular area of a plant, products used over time. More specifically, the data could include the frequency and volumes of utilization of particular products over time. In certain cases the input data may include information concerning the manufacturers and part numbers of the products utilized. The supply configurator module 4032 will examine the data relating to the history of product utilization and determine which products it is has previously encountered (e.g., by matching part numbers and/or manufacturers of the products) to previously stored product information, and will also determine which portions of the product utilization history relate to unknown products.

As is discussed in greater detail below, the supply configurator module 4032 then attempts to identify and characterize (e.g., determine product dimensions) each product included within the imported product utilization history. This process continues until all products have been characterized and all options for containing such products in storage modules of varying sizes have been determined (FIGS. 41A and 41B). Once all products have been characterized and all potential storage options for all products have been evaluated (stage 4108), a set of storage modules which best optimize a specified design criteria and/or constraints (e.g., lowest cost, minimum floor footprint, minimum cubic volume, desired work surface area, etc.) are selected, a corresponding rack arrangement is configured, and power, communicating and skinning/branding requirements are determined (stages 4182-4186). Once this supply cabinet system configuration is accepted (stage 4187), the supply configurator module 4032 generates an electronic representation of a supply cabinet system configuration usable to assemble a corresponding physical supply cabinet system (stage 4188).

Referring again FIG. 41A, for each product included within the imported product utilization history, a search is performed of a given customer's catalog 4038 (stage 4112) to determine if a match exists (stage 4114). Effectively this involves taking the data from the uploaded product utilization history and determining whether an existing customer (i.e., end user of the product) is involved and, if so, has the customer already used the product in question. For example, a customer may utilize an internal part number (e.g., “abc123”) in the customer's ERP system. If “abc123” has previously been identified, then the supply configurator module 4032 can determine that the customer's internal part number of “abc123” corresponds to “3M sandpaper model XYZ”. In the case in which the product identifier being evaluated (“abc123”) matches a product identifier which has previously been identified and is therefore included within the customer's catalog 4038 (stage 4114), the supply configurator module 4032 concludes that the product identifier being evaluated has been positively identified and moves on to iterate through all storage modules option (i.e., all storage module types and sizes thereof) to determine the number of units of the product capable of being contained within each storage module option. However, if the product identifier being evaluated (“abc123”) does not match a product identifier which has previously been identified and added to the customer's catalog 4038 (stage 4114), then the supply configurator module 4032 searches through the Supply Pro catalog 4040 (stage 4116). In one embodiment the Supply Pro catalog 4040 effectively includes dimensional and other information on all products that system operator has previously validated as being capable of inclusion in one or more storage modules. By virtue of this validation process the system operator has confirmed that all products within the Supply Pro catalog 4040 have correct dimensions and therefore fit within those storage module compartments known to accommodate products of such dimensions. If the product identifier being evaluated (“abc123”) matches a product identifier within the Supply Pro catalog 4040 (stage 4118), it is added to the customer's product catalog 4038 (stage 4120).

If the product identifier being evaluated (“abc123”) does not match a product identifier within the Supply Pro catalog 4040 (stage 4118), then the supply configurator module 4032 searches through the distributor's catalog 4042 (stage 4122). The distributor's catalog 4042 effectively includes descriptions and specification of all industrial supplies and other products sold by the distributors 4010. If the product identifier being evaluated (“abc123”) matches a product identifier within the distributor's catalog 4042 (stage 4124), it is added to the Supply Pro catalog 4040 (stage 4126).

In one embodiment the supply configurator module 4032 can match part number information and specifications for a given product or item maintained by one distributor 4010 to corresponding part number information and specifications maintained by another distributor 4010 for the same product. That is, the supply configurator module 4032 can effectively create and store, within the distributor's catalog 4042, an association between the new/old distributor part numbers for a given item. It is generally not possible for distributors 4010 to independently develop this association since they will typically be mutually unaware of the other's part numbering and specification schemes.

If the product identifier being evaluated (“abc123”) does not match a product identifier within the distributor's catalog 4042 (stage 4124), then the supply configurator module 4032 searches through a manufacturer's catalog 4044 (stage 4128). In one embodiment the manufacturer's product catalog 4044 includes data collected by the system operator over an extended time period (e.g., several years or at least months). If the product identifier being evaluated matches a product identifier within the manufacturer's product catalog 4044 (stage 4130), the product identifier is added to the distributor's catalog 4042 (stage 4132). If the product identifier being evaluated does not match a product identifier within the manufacturer's product catalog 4044 (stage 4130), then in one embodiment it is attempted to obtain a match using heuristics. For example, the supply configurator module 4032 may attempt to match the weight, diameter and or other physical dimensions of the product being evaluated to dimensional or other specifications included within the manufacturer's catalog 4044. If this is unsuccessful then a search for the product identifier being evaluated, and/or a search based upon its dimensional specifications, may be conducted using public sources of product information such as, for example, the websites of major online retailers (stage 4144). If the product identifier being evaluated matches a product identifier found in public sources of product information (stage 4146), then it is added to the distributor's catalog 4042 (stage 4148); otherwise, the product identifier may be flagged for human intervention (stage 4150).

Once a product has been identified (stages 4112-41450), a process of attempting to fit a desired quantity of the product within essentially all available storage module configurations (e.g., storage module type and size) is initiated. In one embodiment the supply configurator module 4032 uses the imported product utilization history provided by the customer to calculate the number of units of the product that were used by the customer over some time frame. The supply configurator module 4032 may then adjust this preliminary product usage number based upon, for example, the frequency at which the customer or distributor wants to restock the configurable supply cabinet. In addition, the supply configurator module 4032 may employ a safety stock algorithm to ensure overstocking of the product by a reasonable percentage to avoid the likelihood of a stock-out condition at some point during or prior to the next restocking. So in this way a target storage quantity of the product is determined based upon an anticipated restocking frequency and a safety stock margin (stage 4154).

Referring to FIGS. 41A and 41B, once a product within the imported product utilization history has been identified and its dimensional specifications determined (stages 4112-4148), and after a target storage quantity for the product has been determined (stage 4154), a process of iterating through all potential sizes of each type of storage module capable of being utilized to store the product in the configurable storage cabinet is initiated (stage 4158). In one embodiment this iterative process is carried out by the supply configurator module 4032 by performing the operations represented by stages 4160-4178. These operations are intended to identify the sizes of each type storage module capable of accommodating ones of the identified product and, additionally, the type and size of storage module capable of optimally storing the identified product. In this sense optimally means the type and size of storage module which best satisfies criteria provided by the customer with respect to one or more design parameters (e.g., storage footprint, cost, etc.). Stated differently, the system operator can pull the appropriate levers at the beginning of the iterative process in order to specify a preference for, for example, the most compact supply cabinet system or the most inexpensive supply cabinet system. Certain types of storage modules may be excluded from consideration based upon distributor preferences. For example, certain distributors may prefer not to sell certain types of modules. As a specific example, one distributor may prefer not to sell supply cabinets having coil-based dispensing systems. In this case the supply configurator module 4032 would exclude such systems even though their use could have provided a more compact configuration or a less expensive configuration.

Referring to FIGS. 41A and 41B, once a target storage quantity for the product has been determined (stage 4154), the process of evaluating all storage module configurations (stage 4158) is initiated by selecting a first of the available storage modules for consideration (stage 4160). The length and width of the initially selected storage module will typically be initially set to values of zero, thereby setting the capacity of the initially selected storage module to zero (stage 4161). When the selected storage module is set to a storage capacity of zero, the supply configurator module 4032 determines that the selected module cannot hold any units of the product. Since all dimensional variations of the selected storage module will not yet have been tested to contain the product under consideration (stage 4162), the length, width and height of the selected storage module are then incrementally increased above zero so as to incrementally increase the usable storage capacity of the storage module to the next variation in storage capacity (stages 4164, 4166). After each increment in storage capacity, the supply configurator module 4032 will determine how many units of the product may be contained by the storage module at different three-dimensional orientations of the product within the selected storage module under the constraint that all units within the storage module will have the same three-dimensional orientation when packed (stages 4168-4174). This enables the supply configurator module 4032 to set the capacity of the particular storage module configuration (i.e., a specific length, width and height of the selected storage module type) at each of a plurality of packing orientations of the product within the storage module configuration (stage 4175). In alternate embodiments the supply configurator module 4032 could operate under different constraints with respect to product orientation within storage modules. For example, in cases in which multiple layers of a product are to be packed in a given storage module, the supply configurator module 4032 could determine that the packing scheme yielding the highest density (i.e., highest capacity) involves packing products in different orientations (in a three-dimensional coordinate system) when packed in different layers within the storage module (e.g., products within a first layer are all packed in a first orientation, products in a second layer are placed in a second orientation orthogonal to the first orientation, etc.).

In one embodiment the supply configurator module 4032 repeats, with respect to the product under consideration, this processing loop (i.e., stages 4162-4175) until the unit capacity of all storage module configurations has been determined. At the completion of this process with respect to a given product, the supply configurator module 4032 will be aware of the quantity of the product that may be contained within each possible storage module configuration. In the exemplary embodiment of FIG. 41, the supply configurator module 4032 continues to evaluate relatively larger capacity variations of a selected storage module type even after it has determined that a smaller-size version of the selected storage module type is capable of containing the target quantity of the product under consideration. This is because the supply configurator module 4032 may, in order to optimize certain design parameters, opt to select storage module configurations other than the smallest storage module configuration capable of containing the target number of units of a given product. For example, in order to configure the supply cabinet to provide a suitable work surface at a desired height, it may be necessary to select storage module configurations somewhat larger than the minimum-sized storage module configurations capable of containing targeted quantities of one or more products.

In one embodiment the supply configurator module 4032 repeats this processing loops of illustrated in FIGS. 41A and 41B until the capacity of all storage module configurations with respect to all products to be stocked within the configurable supply cabinet have been determined. So if there are 1000 products on the inventory list for stocking in the configurable supply cabinet, the supply configurator module 4032 will continue executing the processing loops of FIGS. 41A and 41B until the product unit storage capacities of each storage module configuration with respect to each of the 1000 products have been determined.

Once the supply configurator module 4032 has identified all products in the imported product utilization history, flagged any products which are unable to be identified, and determined the unit storage capacity for each storage module variation with respect to each product (stage 4108), the supply configurator module 4032 executes the operations depicted in FIG. 41C (stages 4182-4188). These operations essentially result in selection of an ideal supply cabinet configuration; that is, a supply cabinet configuration which has been optimized in view of one or more preferred parameters (least expensive, most compact, etc.).

As shown in FIG. 41C, an initial step in developing an optimized supply cabinet system configuration once storage module capacities for all products have been determined (stage 4108) involves selecting one storage module configuration (storage module type and size) for each product. As an example, in the case in which 1000 products are to be stocked within the resulting supply cabinet, 1000 corresponding storage module configurations would be selected (stage 4182). Because storage modules having multiple doors/compartments hold more than one SKU at a time (e.g., certain storage modules may include 9 doors), the supply configurator module 4032 will initially use only 1 door of each multi-door module for storage of a given product (leaving the remaining doors of the storage module available to store other products). The supply configurator module 4032 then executes a consolidation operation (stage 4183). As an example of this operation, consider a case in which the supply configurator module 4032 has identified 40 products having unit sizes capable of being contained within compartments within a 9-door/compartment storage module. If the supply configurator module 4032 determines that 36 of the products could be included within a set of the 9-door/compartment storage modules and 4 of the products would occupy compartments of an additional 9-door/compartment storage module, then a number of compartments (e.g., 5) of the additional 9-door storage module would remain unoccupied. In this situation the supply configurator module 4032 may determine that a more efficient approach would be to use a 6 door storage module (which is larger and therefore less compact than the 9-door storage module) if a set of 6-door storage modules could be completely filled by the 40 products (i.e., have no remaining unfilled compartments). So by using 6-door storage modules the inefficiency of using a 9-compartment/door storage module that would be approximately half empty when stocked is avoided. To summarize, the supply configurator module 4032 may determine that using storage modules having slightly larger compartments than necessary to accommodate units of the product of interest may be more space efficient if it enables each storage module to be completely filled and not have an unused capacity.

In one embodiment the supply configurator module 4032 implements the consolidation operation (stage 4183) by consolidating the target quantity of units of the given product from smaller storage modules into partially-filled larger storage modules. Stated differently, the supply configurator module 4032 will start by allocating the target quantity of the product to the largest storage modules and working its way down to allocating the products to the smallest storage modules, at each step shifting product units to larger storage modules until all available space is occupied. At this point the supply configurator module 4032 knows the exact number and size (e.g., double deep and double wide) of storage modules necessary to contain the target quantity of the product.

In a stage 4184, the supply configurator module 4032 then configures the rack system for the supply cabinet based upon the number and size of the storage modules determined in stage 4183. Since the configuration of the rack system affects the overall size and shape of the supply cabinet, in one embodiment the supply configurator module 4032 may be constrained by, for example, distributor and/or customer preferences or requirements when configuring the rack system. For example, the customer may specify that the supply cabinet provide at least some counter space, and/or a distributor may specify that this counter space be at “desktop” height. Similarly, a particular dealer may elect not to sell supply cabinet systems having certain configurations or footprints. The supply configurator module 4032 will then calculate power, wrapping requirements, and signaling requirements for the supply cabinet system (stage 4185). This enables the supply configurator module 4032 to specify the electronics, power supplies and the like required by the current design of the supply cabinet system.

The supply configurator module 4032 may then generate a target configuration and product planogram and present it to the customer (stage 4186). In one embodiment the supply configurator module 4032 generates both a fully written proposal and an electronic version of the proposal that the customer may adjust and manipulate. The planogram will typically include: (i) a list of products to be stored by the supply cabinet system, (ii) the quantity of each of those products the system will preferably store, i.e., the “target maximum”, (iii) the larger quantities of the products which the cabinet system could store, i.e., the “physical maximum” (since in certain cases the supply cabinet system could be capable of storing higher product quantities than are actually needed in view of the imported historical product utilization data), and (iv) the restocking intervals upon which the system design is based. This enables a customer to, for example, adjust the assumed restock interval and/or add additional safety stock and then be presented with a modified supply cabinet system configuration. Once the customer is satisfied with the proposed configuration of the supply cabinet system, the supply configurator module 4032 receives an indication of the customer's acceptance of the proposed configuration (stage 4187).

In one embodiment the supply configurator module 4032 then creates an electronic representation of the supply cabinet system, sets inventory data, and generates a purchase quote (stage 4188). This electronic representation is communicated to the cabinet assembly facility 4050 at which the supply cabinet system is physically assembled and can facilitate its assembly on the manufacturing floor. As an example, consider a scenario in which a 1-door storage module is erroneously inserted at a particular location within the rack arrangement specified for the supply cabinet system; that is, insertion of the 1-door storage module at this location conflicts with the configuration specified in the electronic representation of the supply cabinet system generated by the supply configurator module 4032. In this case the control unit 124 of the supply cabinet system would then issue an interrupt or alert accompanied by, for example, a message informing the assembly personnel of the correct location (if any) at which the 1-door storage module should be inserted into the cabinet system's rack arrangement.

In one embodiment the control unit 124 of the supply cabinet system also utilizes the electronic copy of the product order generated by the supply configurator module 4032 to facilitate the loading of such products into the appropriate storage compartments in the target configuration of the supply cabinet system. Specifically, the control unit 124 of the supply system will go line-by-line through the electronic copy of the product order and provide corresponding instructions to the operator. For example, the processor may indicate that pens specified in the order are to be stored in a particular storage module by, for example, highlighting that portion of the order on a display of the cabinet system and actuating a light or other indicator on the appropriate storage compartment or drawer. In this way the system essentially takes automates the previously manual process of loading the target configuration of the cabinet supply system with the products specified by the electronic product order by walking the operator through the steps of loading the appropriate number of items from the order into each cabinet compartment.

In one embodiment the supply configurator module 4032 may be executed to produce an updated supply cabinet system configuration in response to changed requirements and/or needs of the customer. For example, the supply configurator module 4032 could accept as a design constraint the configuration of an existing supply cabinet system and then suggest additions or modifications to the existing supply cabinet system in response to, for example, increases or changes in the quantities or compositions of the parts used by the customer.

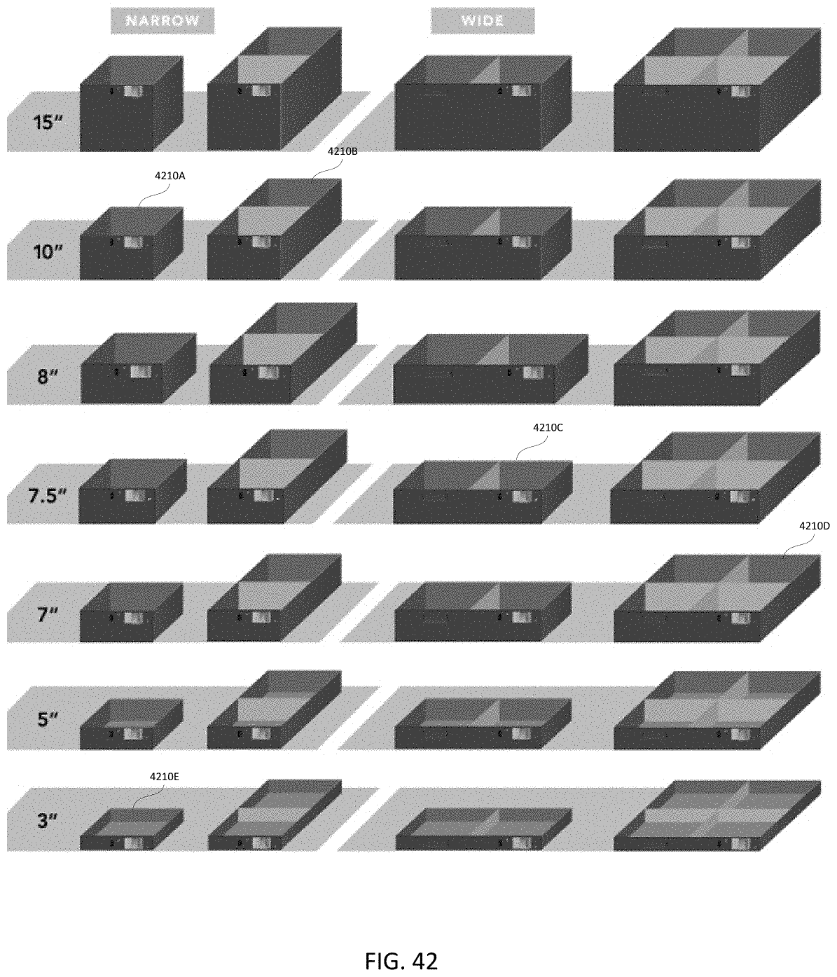

FIG. 42 illustrates an exemplary set of drawer structures 4210 which may be utilized within supply cabinet system configurations. In one embodiment the supply configurator module 4032 selects a combination of drawer structures for use within a particular supply cabinet system configuration based upon a rack size selected or specified for the configuration. Drawers implemented using the drawer structures of FIG. 42 can generally accommodate 1, 2 or 4 drawer storage units with the capacity from 1 SKU to 9 SKU's. Of course in other embodiments alternate drawer structures having different capacities may be utilized.

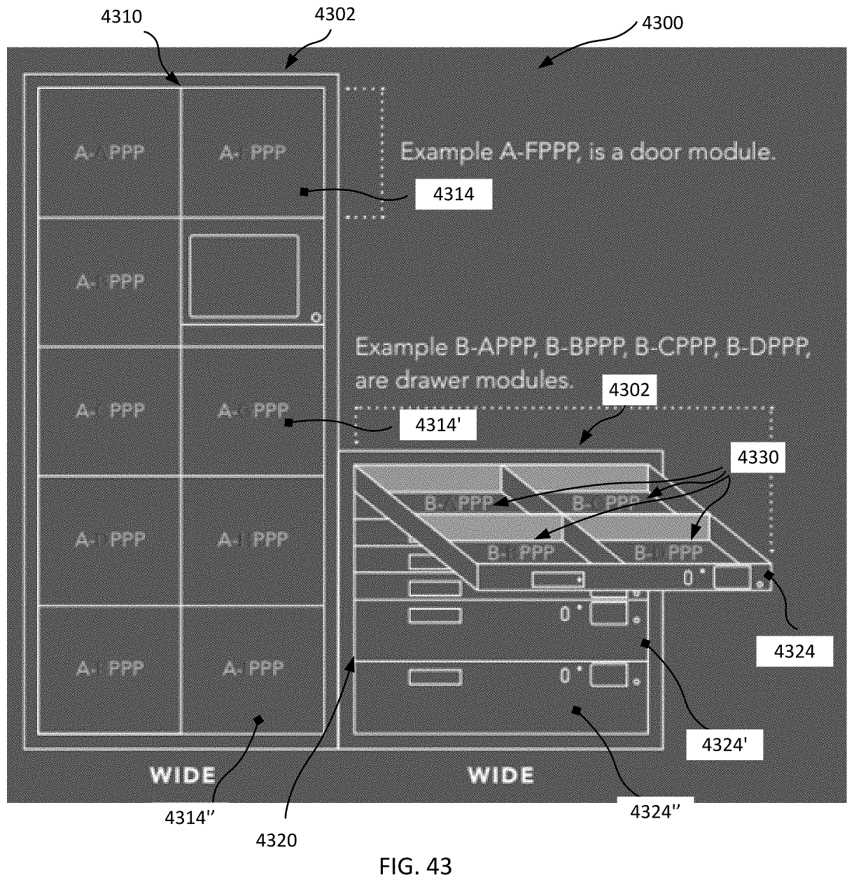

FIGS. 43-45 illustrate examples of various different types of supply cabinet system configurations which may be produced by the supply configurator module 4032. The racks, modules and drawers within the supply cabinet system configurations of FIGS. 43-46 may also be alphanumerically identified in the manner described below to enable the location of items within a given supply cabinet system to be easily identified. For example, in one embodiment a unique identifier of the form “R-MPPP” may be associated with each storage location within a supply cabinet system, where “R” identifies a rack within the system, “M” identifies a module within the identified rack, and “PPP” corresponds to a position within the identified module. In one embodiment the value of “R” ranges from A to Z, the value of “M” ranges from A to Z, and the value of PPP ranges from 001 to 999.

Racks may be, for example, single or double wide within a single frame. As racks are added to a system, in one embodiment each rack within a single frame one is identified with an “A”, “B”, “C”, etc., i.e., alphabetically from left to right.

Turning now to FIG. 43, a supply cabinet system 4300 having a frame 4302 containing a first rack 4310 and a second rack 4320 is shown. The first rack 4310 of the supply cabinet system is associated with the identifier “A” and includes a plurality of door modules 4314. In one embodiment the door modules within a rack are identified with alphanumeric identifiers in a progression from top to bottom, left to right. For example, in FIG. 43 the door modules “A”. “B”, “C”, “D” and “E” run from top to bottom on the left side of rack 4310 and the door modules “F”, “G”, “H” and “I” run from top to bottom on the right side of rack 4310.

The second rack 4320 includes a set of drawers 4324 and each of these includes one or more drawer modules. The second rack is associated with the identifier “B”. As shown, a topmost drawer 4324 included within the rack 4320 includes a set of four drawer modules 4330. In one embodiment drawer modules are alphanumerically identified in a progression from back to front, left to right. Accordingly, the drawer modules 4330 may be identified B-APPP, B-BPPP, B-CPPP, B-DPPP, where “PPP” are three-digit numerical values (e.g., “001”, “002”, “003” and “004”).

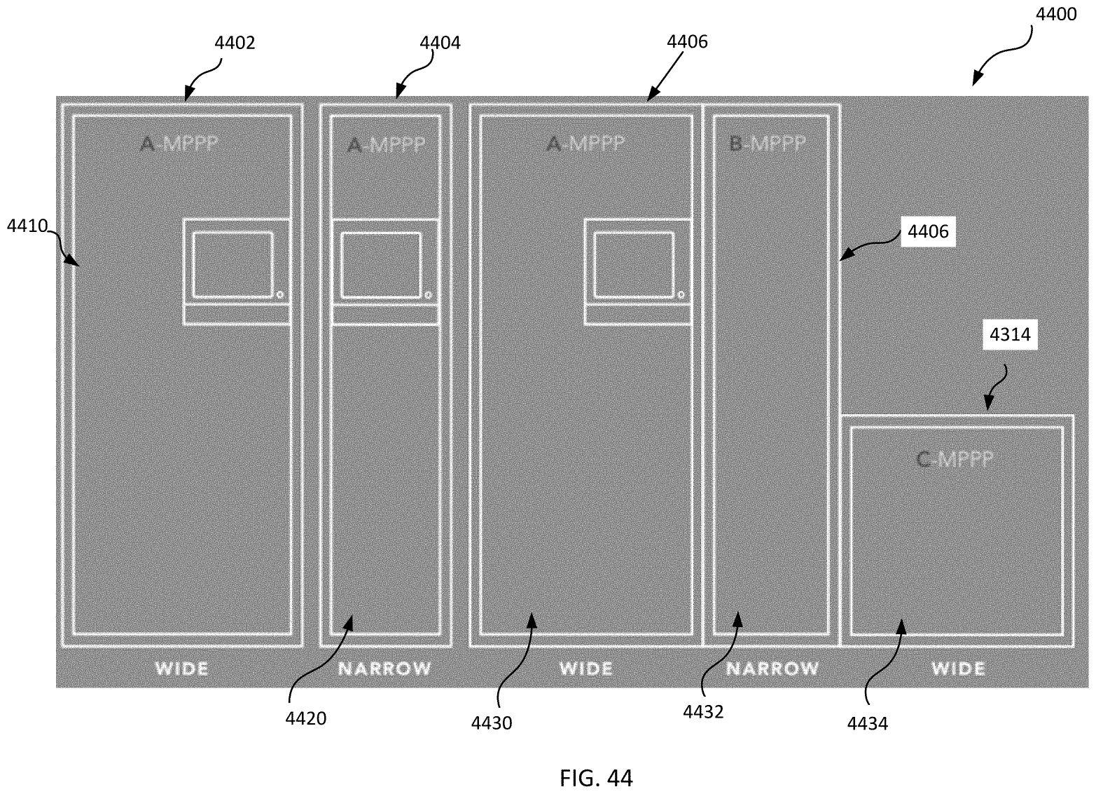

Attention is now directed to FIG. 44, which depicts a supply cabinet system 4400 comprised of a first frame 4402, a second frame 4404 and a third frame 4406. The first frame 4402 includes a first rack 4410, the second frame 4404 includes a second rack 4420 and the third frame 4406 includes third, fourth and fifth racks 4430, 4432 and 4434. Since the first frame 4402 and the second frame 4404 each include only a single rack, both the first rack 4410 within the first frame 4402 and the second rack 4420 within the second frame 4404 are identified by “A”. The third, fourth and fifth racks 4430, 4432 and 4434 within the third frame 4406 are identified by “A”, “B” and “C”, respectively.

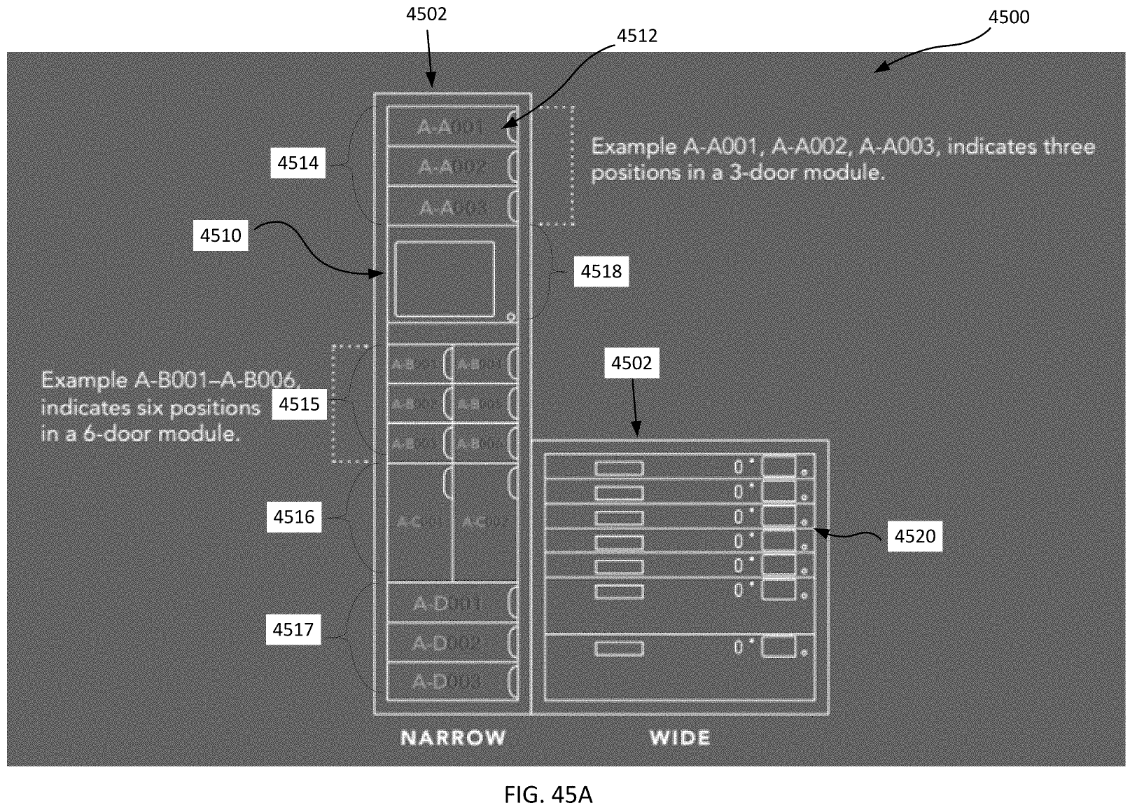

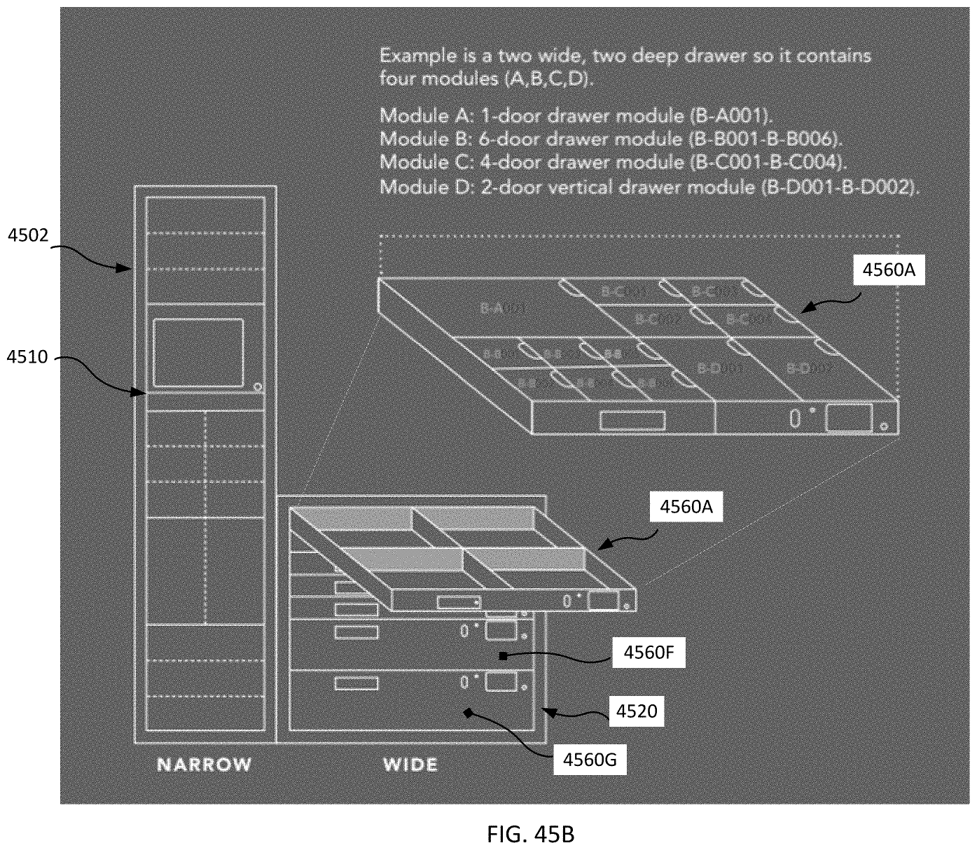

Turning now to FIGS. 45A and 45B, a supply cabinet system 4500 having a frame 4502 containing a narrow rack 4510 and a wide rack 4520 is shown. The narrow rack 4510 includes a first module 4514, a second module 4515, a third module 4516, a fourth module 4517 and a control module 4518. As shown, a first storage location 4512 within the first module 4514 of the rack 4510 is uniquely identified by the location identifier “A-A001”, where the “A” in the first position of the location identifier corresponds to the rack 4510, the “A” in the second position of the location identifier corresponds to the first module 4514, and the “001” in the last three positions of the location identifier correspond to the first storage location within the module 4514.

Referring to FIG. 45A, the unique identifiers A-A001, A-A002, A-A003, indicate three positions in the 3-door first module 4514. Similarly, A-B001-A-B006, indicate six positions in the 6-doors second module 4515.

Turning to FIG. 45B, the wide rack 4520 includes a set of drawers 4560A-4560G. As shown, drawer 4560A is a two wide, two deep drawer containing four modules (A, B, C, D). Module A disposed within drawer 4560A is 1-door drawer module identified by the unique identifier “B-A001”, where the “B” in the first position of the unique identifier corresponds to the wide rack 4520. Module B within drawer 4560A is a 6-door drawer module (B-B001 to B-B006). Module C within drawer 4560A is a 4-door drawer module (B-0001 to B-0004). Module D within drawer 4560A is a 2-door vertical drawer module (B-D001 to B-D002).

In some configurations, the apparatus or system includes means for performing various functions as described herein. In one aspect, the aforementioned means may be a module including a processor or processors and associated memory in which embodiments of the invention reside, such as are shown in the preceding drawings and which are configured to perform the functions recited by the aforementioned means. This may be, for example, modules or apparatus residing in client devices, host server systems, and/or other network devices such as are shown and/or described herein. In another aspect, the aforementioned means may be a module or apparatus configured to perform the functions recited by the aforementioned means.

In one or more exemplary embodiments, the functions, methods and processes described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

As used herein, computer program products comprising computer-readable media including all forms of computer-readable medium except, to the extent that such media is deemed to be non-statutory, transitory propagating signals.

It is understood that the specific order or hierarchy of steps or stages in the processes and methods disclosed are examples of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps or stages of a method, process or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. This includes all types of puzzle games where players are given a fixed number of moves to complete the goals.

The disclosure is not intended to be limited to the aspects shown herein, but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the principles and novel features disclosed herein.

What is claimed is:

1. A method of producing a supply cabinet system configured to dispense a plurality of items, the method comprising:
obtaining product dimension characteristics of the plurality of items wherein the product dimension characteristics include physical dimensions for a plurality of item types included within the plurality of items;
for each item type of the plurality of item types:
determining a number of units of the item type capable of being contained within each of a plurality of dimensional variations of each of a plurality of storage module types;
selecting one of a plurality of storage module configurations to contain a target number of the items of the item type wherein the selected storage module configuration corresponds to one of the plurality of dimensional variations of one of the plurality of storage module types;
determining a rack arrangement to hold the selected storage module configurations for the plurality of item types, the rack arrangement and the selected storage module configurations forming at least a part of a supply cabinet configuration; and
assembling, in accordance with the supply cabinet configuration, the supply cabinet system using a set of storage modules corresponding to the selected storage module configurations and a set of rack members corresponding to the rack arrangement.

2. The method of claim 1 wherein the determining characteristics of the plurality of items includes:
receiving product utilization information indicative of typical usage of ones of the plurality of items;
developing, using the product utilization information, a list of part numbers corresponding to ones of the plurality of items;
determining, for each of the part numbers, whether a corresponding product item has been previously validated as being capable of being contained in at least one of the storage module configurations.

3. The method of claim 2, further including:
determining, for one of the part numbers, that a product item corresponding to the one of the part numbers has not been previously validated as being capable of being contained in at least one of the storage module configurations;
obtaining physical specifications for the one of the part numbers from database records associated with at least one of a distributor or a manufacturer of a product item corresponding to the one of the part numbers.

4. The method of claim 1, further including:
receiving product utilization information indicative of typical usage of ones of the plurality of items;
developing, using the product utilization information, a list of part numbers corresponding to ones of the plurality of items.

5. The method of claim 4 wherein the number of the items of each one of the plurality of item types contained within corresponding ones of the plurality of storage module configurations is determined based at least in part upon the product utilization information.

6. The method of claim 1 wherein the determining includes determining, for each item type of the plurality of item types, numbers of units of the item type capable of being contained within each of a plurality of dimensional variations of each of a plurality of storage module types for each of a plurality of item orientations.

7. A supply cabinet system configured to dispense a plurality of items, the supply cabinet system comprising:
a rack arrangement;
a set of storage modules disposed within the rack arrangement wherein the set of storage modules correspond to a set of selected storage module configurations, each of the selected storage module configurations:
being dimensioned to contain a number of units of an item type included among a plurality of item types,
corresponding to one of a plurality of potential dimensional variations of one of a plurality of storage module types;
wherein the set of selected storage module configurations are determined in accordance with a design parameter, the design parameter relating to one of space minimization, cost and a surface configuration of the supply cabinet system.

8. The supply cabinet system of claim 7 wherein different ones of the plurality of storage module types include different numbers of access doors.

9. A method of facilitating production of a supply cabinet system configured to dispense a plurality of items, the method comprising:
obtaining product dimension characteristics of the plurality of items wherein the product dimension characteristics include physical dimensions for a plurality of item types included within the plurality of items;
for each item type of the plurality of item types:
determining a number of units of the item type capable of being contained within each of a plurality of dimensional variations of each of a plurality of storage module types;
selecting one of a plurality of storage module configurations to contain a target number of the items of the item type wherein the selected storage module configuration corresponds to one of the plurality of dimensional variations of one of the plurality of storage module types;
determining a rack arrangement to hold the selected storage module configurations for the plurality of item types, the rack arrangement and the selected storage module configurations forming at least a part of a supply cabinet configuration;
wherein the supply cabinet configuration is usable to assemble the supply cabinet using a set of storage modules corresponding to the selected storage module configurations and a set of rack members corresponding to the rack arrangement.

10. The supply cabinet system of claim 7 wherein the rack arrangement includes a first rack, a second rack and a third rack, the first rack being disposed within a first frame and the second rack and the third rack being disposed within a second frame.

11. The method of claim 9 wherein the rack arrangement includes a first rack, a second rack and a third rack, the first rack being disposed within a first frame and the second rack and the third rack being disposed within a second frame.

12. The method of claim 9 further including receiving design criteria provided by a user, the method further including utilizing the design criteria in determining the rack arrangement.

13. The method of claim 12 wherein the design criteria relates to a desired workspace area.
